(19) United States
(12) Patent Application Publication
(10) Pub. No.: US 2026/0005730 A1
(43) Pub. Date: Jan. 1, 2026

(54) DETECTING UNINTENDED SIGNAL REFLECTIONS IN RECONFIGURABLE INTELLIGENT SURFACES

(71) Applicant: QUALCOMM Incorporated, San Diego, CA (US)

(72) Inventors: Ahmed ELSHAFIE, San Diego, CA (US); Wanshi CHEN, San Diego, CA (US); Yu ZHANG, San Diego, CA (US); Zhikun WU, Beijing (CN); Hung Dinh LY, San Diego, CA (US)

(21) Appl. No.: 19/111,919

(22) PCT Filed: Nov. 23, 2022
(86) PCT No.: PCT/CN2022/133627

§ 371 Date: Mar. 14, 2025

(51) Int. Cl. H04B 7/04

(52) U.S. Cl. CPC H04B 7/04013

(57) ABSTRACT

Wireless communications systems, apparatuses, and methods are provided. A method of wireless communication performed by a network unit includes transmitting, to one or more user equipment (UEs), one or more first reference signals, transmitting, to the one or more UEs, one or more second reference signals, and detecting an unintended signal reflection associated with a reconfigurable intelligent surface (RIS) based on a comparison of first measurements associated with the one or more first reference signals with second measurements associated with the one or more second reference signals.

### TECHNICAL FIELD

This application relates to wireless communication systems, and more particularly, to detecting unintended signal reflections in reconfigurable intelligent surfaces.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a network unit may include transmitting, to one or more user equipment (UEs), one or more first reference signals; transmitting, to the one or more user equipment (UEs), one or more second reference signals; and detecting an unintended signal reflection associated with a reconfigurable intelligent surface (RIS) based on a comparison of first measurements associated with the one or more first reference signals with second measurements associated with the one or more second reference signals.

In an additional aspect of the disclosure, a method of wireless communication performed by a user equipment (UE) may include receiving, from a network unit, one or more first reference signals associated with a reconfigurable intelligent surface (RIS); receiving, from the network unit, one or more second reference signals associated with the RIS; and transmitting an indicator indicating a comparison of first measurements associated with the one or more first reference signals with second measurements associated with the one or more second reference signals.

In an additional aspect of the disclosure, a network unit may include a memory; a transceiver; and at least one processor coupled to the memory and the transceiver, wherein the network unit is configured to transmit, to one or more user equipment (UEs), one or more first reference signals; transmit, to the one or more user equipment (UEs), one or more second reference signals; and detect an unintended signal reflection associated with a reconfigurable intelligent surface (RIS) based on a comparison of first measurements associated with the one or more first reference signals with second measurements associated with the one or more second reference signals.

In an additional aspect of the disclosure, a user equipment (UE) may include a memory; a transceiver; and at least one processor coupled to the memory and the transceiver, wherein the UE is configured receive, from a network unit, one or more first reference signals associated with a reconfigurable intelligent surface (RIS); receive, from the network unit, one or more second reference signals associated with the RIS; and transmit an indicator indicating a comparison of first measurements associated with the one or more first reference signals with second measurements associated with the one or more second reference signals.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates an unintended signal reflection associated with a RIS according to some aspects of the present disclosure.

FIG. 4 illustrates reference signal transmission in a wireless communication network according to some aspects of the present disclosure.

FIG. 5 illustrates reference signal transmission in zones of a wireless communication network according to some aspects of the present disclosure.

FIG. 6 illustrates reference signal transmission in zones of a wireless communication network according to some aspects of the present disclosure.

FIG. 7 illustrates a master node UE in zones of a wireless communication network according to some aspects of the present disclosure.

FIG. 8 illustrates timing of reference signal transmission in a wireless communication network according to some aspects of the present disclosure.

FIG. 9 is a signal flow diagram of a communication method according to some aspects of the present disclosure.

FIG. 10 is a block diagram of an exemplary user equipment (UE) according to some aspects of the present disclosure.

FIG. 11 is a block diagram of an exemplary network unit according to some aspects of the present disclosure.

FIG. 12 is a flow diagram of a communication method according to some aspects of the present disclosure.

FIG. 13 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3^{rd} Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannel) in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

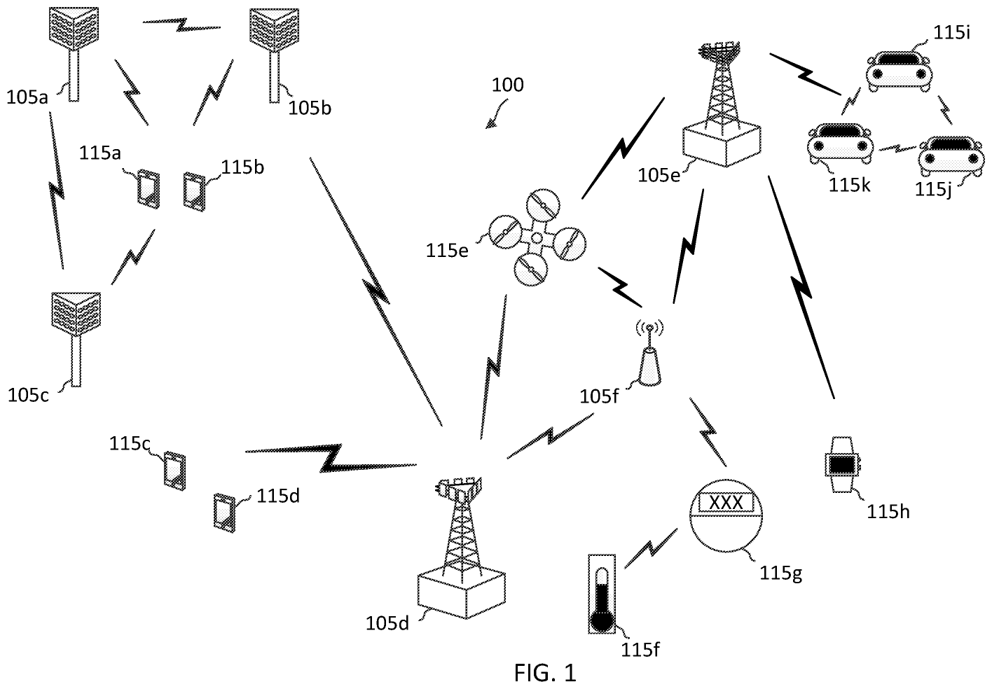

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the BS 105 may transmit one or more first reference signals to one or more UEs 115. The BS 105 may transmit one or more second reference signals to the one or more UEs 115. The BS 105 may detect an unintended signal reflection associated with a reconfigurable intelligent surface (RIS) based on a comparison of first measurements associated with the one or more first reference signals with second measurements associated with the one or more second reference signals.

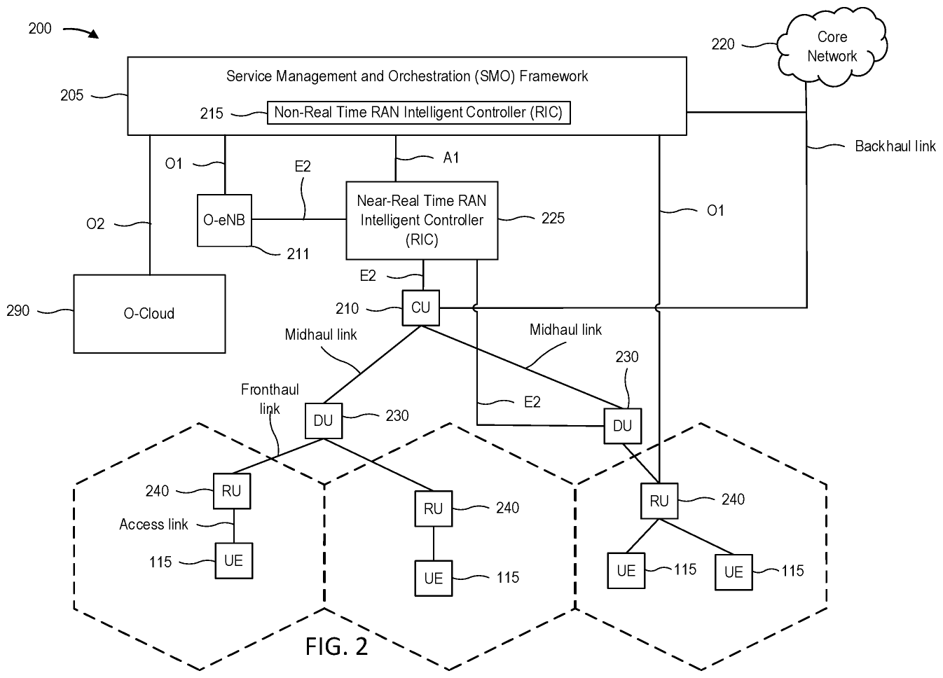

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In some aspects, the RU 240 may transmit one or more first reference signals to one or more UEs 115. The RU 240 may transmit one or more second reference signals to the one or more UEs 115. The RU 240, the DU 230, or the CU 210 may detect an unintended signal reflection associated with a reconfigurable intelligent surface (RIS) based on a comparison of first measurements associated with the one or more first reference signals with second measurements associated with the one or more second reference signals.

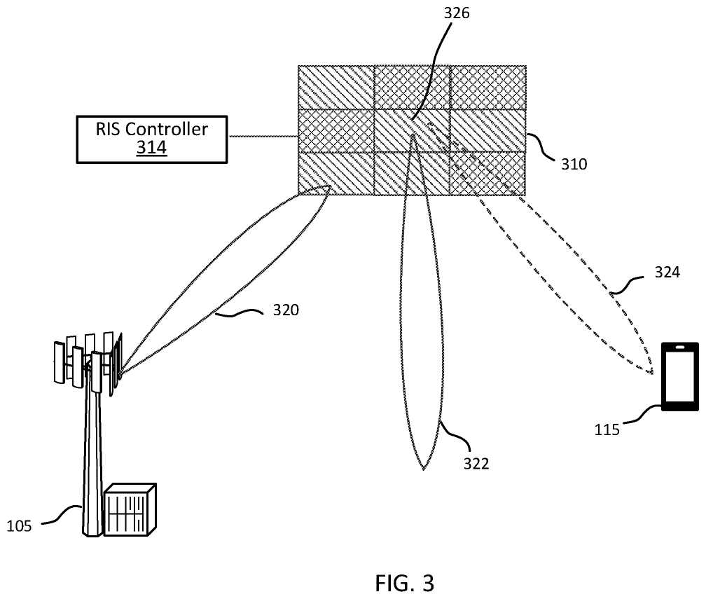

FIG. 3 illustrates an unintended signal reflection 322 associated with a RIS 310 according to some aspects of the present disclosure. In some aspects, the network unit 105 may detect an unintended signal reflection 322 associated with the RIS 310. The network unit 105 may detect the unintended signal reflection 322 based on a comparison of measurements associated with one or more first reference signal(s) with measurements associated with one or more second reference signal(s). In this regard, detecting the unintended signal reflection 322 associated with the RIS 310 may include detecting a hack and/or interference associated with a controller 314 of the RIS. The RIS may include a controller 314 (e.g., a microcontroller, a processor 1002, a processor 1102, a field programmable gate array, or other suitable controller) that controls the elements and/or operation of the RIS 310. For example, the network unit 105 may transmit a configuration to the RIS controller 314 to set the reflection angle of the RIS 310. The RIS controller 314 may set the reflection angle one the RIS 310 based on the configuration from the network unit 105. When the RIS is operating according to the network unit configuration setting, the RIS 310 may reflect transmitted signals 320 towards the UE 115 in direction 324. In some aspects, the RIS controller 314 may be hacked and/or otherwise interfered with (e.g., intentionally or unintentionally by a third party) such that the reflection angle of the RIS 310 (e.g., a portion of the RIS 310, a subset of elements of the RIS 310) is changed from the network unit setting thereby causing unintended signal reflection 322. In some aspects, the hack and/or interference may include a malicious hack intended to cause a denial of service to the UE 115.

In response to detecting the unintended signal reflection 322 associated with the RIS 310, the network unit 105 may perform one or more remedial actions. In some aspects, the network unit 105 may attempt to reconfigure the RIS controller 314 to reflect signals in the intended direction 324. The network unit 105 may retransmit the configuration setting to the RIS controller 314, request additional reference signal measurements from the UE 115 to perform additional detection methods, transmit a command to the RIS controller 314 to turn off power to the RIS 310, transmit a command to the RIS controller 314 to disable a portion 326 (e.g., a cluster of elements) of the RIS 310 in which the unintended signal reflection 322 was detected, or other suitable remedial action.

In some aspects, the network unit 105 may detect the unintended signal reflection 322 associated with the RIS 310 based on a probability that the RIS 310 is reflecting signals in an unintended direction. The network unit 105 may detect the unintended signal reflection 322 when the probability satisfies a threshold (e.g., greater than or equal to the threshold). The probability may be determined based on the number of UEs that indicate a difference between the measurements of the first and second reference signal(s) satisfies a threshold (e.g., greater than and/or equal to the threshold). For example, when a threshold number of UEs 115 (e.g., a raw number of UEs and/or a percentage of UEs) in a zone indicate a difference between the measurements of the first and second reference is greater than and/or equal to the threshold, the network unit may consider an unintended signal reflection 322 as having been detected. As another example, when one or more UEs 115 (e.g., a raw number of UEs and/or a percentage of UEs) in a zone indicate a threshold number of comparisons (e.g., a raw number of comparisons and/or a percentage of comparisons) over time indicate a difference between the measurements of the first and second reference is greater than and/or equal to the threshold, the network unit 105 may consider an unintended signal reflection 322 as having been detected.

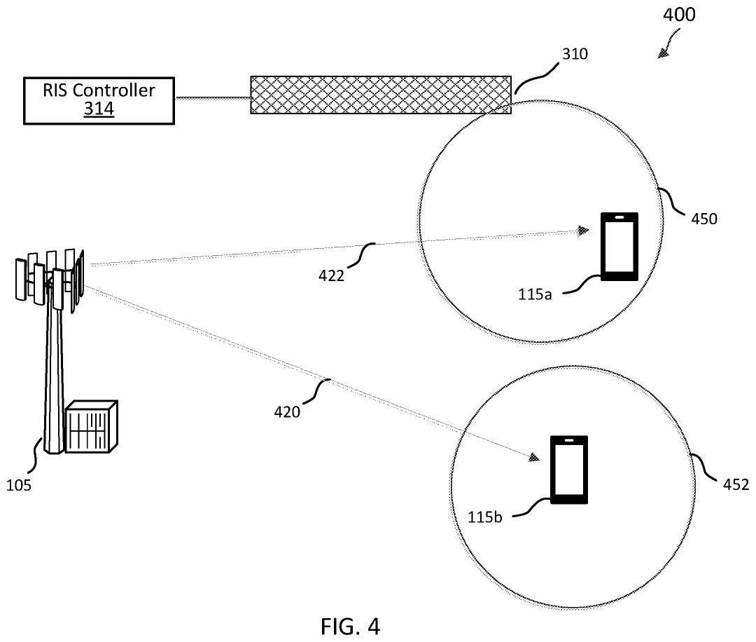

FIG. 4 illustrates reference signal transmission in a wireless communication network 400 according to some aspects of the present disclosure. In some aspects, the network unit 105 may transmit one or more first reference signal(s) to the UE 115a and/or UE 115b. For example, the network unit 105 may directly transmit the first reference signal(s) to the UE 115a in direction 422 without using the RIS 310. The network unit 105 may directly transmit the first reference signal(s) to the UE 115b in direction 420 without using the RIS 310. The first reference signal(s) may include a synchronization signal block (SSB), a primary synchronization signal (PSS), a secondary synchronization signal (SSS), a cell specific reference signal (CRS), a demodulation reference signal (DMRS), a channel state information reference signal (CSI-RS), a phase tracking reference signal (PTRS), and/or other suitable reference signal. For example, when the network unit 105 operates in a new radio (NR) mode, the reference signal(s) may include a synchronization signal block (SSB), a primary synchronization signal (PSS), and/or a secondary synchronization signal (SSS), a demodulation reference signal (DMRS), a channel state information reference signal (CSI-RS), or a phase tracking reference signal (PTRS). When the network unit 105 operates in a long term evolution (LTE) mode, the reference signal may include a cell specific reference signal (CRS).

In some aspects, the UE 115a and/or the UE 115b may measure one or more parameters associated with the first reference signal(s). In this regard, the measurements of the first reference signal(s) may include at least one of a reference signal received power (RSRP) associated with the first reference signal(s), a reference signal received quality (RSRQ) associated with the first reference signal(s), a signal to interference and noise ratio (SINR) associated with the first reference signal(s), a covariance matrix associated with the first reference signal(s), an angle of arrival (AoA) associated with the first reference signal(s), and/or other suitable parameters.

In some aspects, the measurements associated with the first reference signal(s) may represent a baseline set of measurements without reflecting the signals from the RIS 310. The UEs 115a and 115b may perform the measurements periodically. For example, the UEs 115a and 115b may perform the measurements at the reference measurement periodicity. When the UEs 115a and 115b perform reference signal measurements to gain a baseline measurement, the new baseline measurements may replace the previous baseline measurements. Aspects of the present disclosure may determine when the reference signal(s) are reflected by the RIS 310 in an unintended direction based on a comparison of the measurements of the first reference signal(s) with measurements of one or more second reference signal(s).

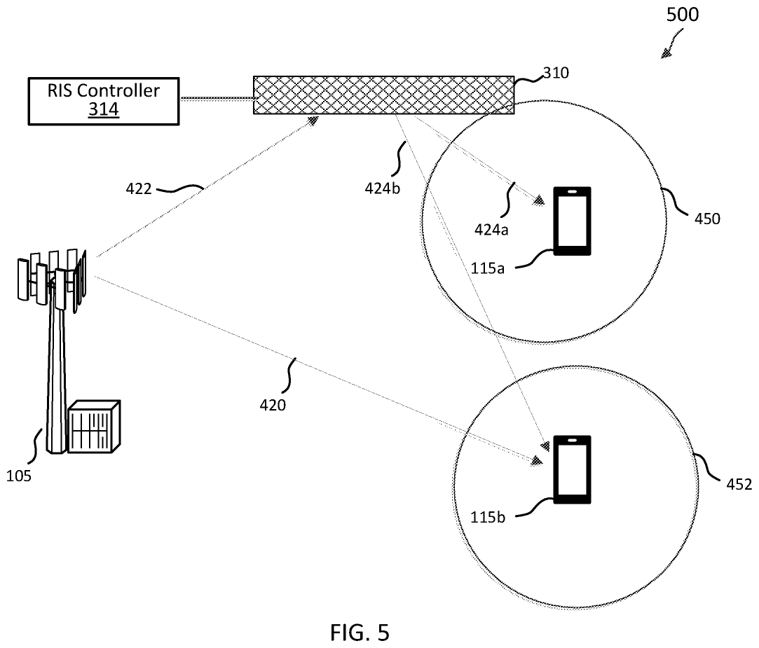

FIG. 5 illustrates reference signal transmission(s) in zones of a wireless communication network 500 according to some aspects of the present disclosure. In some aspects, the network unit 105 may transmit the first reference signal(s) to the UE 115a and/or UE 115b via the RIS 310. In some aspects, the RIS 310 may be deployed to control one or more channels and/or signal propagation paths between the network unit 105 and the UEs 115a and/or 115b. The RIS 310 may control the channel(s) and/or signal propagation path(s) by reflecting, forming, and/or modulating the radio signals from the network unit 105 to the UEs 115a and/or 115b and/or from the UEs 115a and/or 115b to the network unit 105. In some aspects, the RIS 310 may modify an incident radio signal waveform in a controlled manner to enhance and/or improve channel diversities. Increasing channel diversities may provide robustness to channel blocking and/or fading, which may be particularly useful for mmWave communications and other communications. The transmitted (e.g., incident) first reference signal(s) may be reflected by the RIS 310 by adjusting phase shifts that constructively interfere and/or steer the reflected reference signal(s) towards the UEs 115a and/or 115b in order to effectively control multi-path effects. In some instances, the RIS 310 may steer the reflected reference signal(s) through 3-dimensional passive beamforming, thereby improving spectrum and/or energy efficiency. The RIS 310 may be configured to forward (e.g., reflect) a more efficient phase-shifted version of the incident reference signal(s) and/or shape channel propagation to adapt against channel variations due to unpredictable wireless environments.

In some aspects, the network unit 105 may transmit the first reference signal(s) using a transmit beam, a transmit port, and/or a RIS configuration. The transmit beam may include a direction in which the first reference signal(s) are transmitted by the network unit. For example, the network unit 105 may transmit the first reference signal(s) in a direction 420 directly towards the UE 115b. Additionally or alternatively, the network unit may transmit the first reference signal(s) in a direction 422 towards the RIS 310. The network unit 105 may transmit the first reference signal(s) in a direction 422 towards the RIS 310 such that the RIS 310 reflects the reference signal(s) in a direction 424 towards the UE 115a in geographic zone 450 and in direction 424b towards UE 115b in geographic zone 452.

The transmit beam may further include a beam width. For example, the network unit 105 may transmit the first reference signal(s) using a wide beam width covering a wide area and/or a narrow beam width concentrating the reference signal(s) into a narrow area. The transmit port may indicate the antenna port(s) of the network unit used to transmit the first reference signal(s). The RIS configuration may include a configuration transmitted by the network unit 105 to the RIS controller 314. The RIS configuration may include the parameters to be used by the RIS 310 when the first reference signal(s) are reflected towards the UEs 115a and/or 115b. The parameters of the RIS configuration may include angle of reflection, signal amplitude changes, signal polarization changes, signal phase changes, and/or other suitable RIS parameters.

In some aspects, the network unit 105 may transmit one or more second reference signal(s) to the UEs 115a and/or 115b. The second reference signal(s) may include a SSB, a PSS, a SSS, a CRS, a DMRS, a CSI-RS, a PTRS, and/or other suitable reference signal(s). In some aspects, the second reference signal(s) may be the same or different type of reference signal(s) as the first reference signal(s).

In some aspects, the network unit 105 may transmit the second reference signal(s) to the UEs via the RIS 310. In some aspects, the network unit 105 may transmit the second reference signal(s) using the same transmit beam, same transmit port, and same RIS configuration as the first reference signal(s) transmitted by the network unit 105. In some instances, the network unit 105 may transmit the second reference signal(s) using the same transmit beam, same transmit port, and same RIS configuration as the first reference signal(s) in order to facilitate a comparison of measurements between the first and second reference signal(s) based on the same reference signal configuration.

In some aspects, the UE 115a and/or the UE 115b may measure one or more parameter(s) associated with the second reference signal(s). The UE 115a and/or the UE 115b may perform the same measurements as those performed on the first reference signal measurements. In this regard, the measurements of the second reference signal(s) may include at least one of a RSRP associated with the second reference signal(s), a RSRQ associated with the second reference signal(s), a SINR associated with the second reference signal(s), a covariance matrix associated with the second reference signal(s), an AoA associated with the second reference signal(s), and/or other suitable parameter(s).

A comparison of the measurements of the first reference signal(s) with the measurements of the second reference signal(s) may be used to determine if the RIS 310 is operating according to a configuration set by the network unit 105. When the first reference signal(s) are transmitted by the network unit 105 to the UEs 115a and 115b via the RIS 310, the RIS may be in an operating condition in which the RIS 310 reflects the reference signal(s) according to the configuration set by the network unit 105. The RIS 310 may reflect the reference signal(s) in an intended direction according to the configuration set by the network unit 105. For example, the RIS 310 may reflect the reference signal(s) in the intended direction 424a towards the UE 115a. The RIS 310 may reflect the reference signal(s) in the intended direction 424b towards the UE 115b.

In some aspects, the measurements of the second reference signal(s) may occur after the first reference signal measurements (e.g., the baseline measurements) and over one or more times (e.g., periodically). The measurements of the second reference signal(s) may be compared to the first reference signal measurements as a check to determine if the RIS 310 is still operating according to the configuration. The check to determine if the RIS 310 is still operating according to the configuration may be done on a periodic basis. In some aspects, the RIS 310 operational check may be triggered by an event. For example, the event may include the network unit 105 receiving a message requesting to perform the RIS 310 operational check, the network unit 105 detecting one or more radio link failures, or other suitable event. If the comparison of the first reference signal measurements with the second reference signal measurements indicates a difference over a threshold, the RIS 310 (e.g., a portion of the RIS) may not be operating according to the configuration (e.g., the reference signal(s) are reflected in an unintended direction). In some aspect, the RIS 310 may not be operating according to the set configuration based on the RIS controller being hacked.

Additionally or alternatively, the network unit 105 may transmit a request to the UE 115a and/or UE 115b for the measurements of the first reference signal(s) and/or the measurements of the second reference signal(s). In this regard, the network unit 105 may periodically and/or aperiodically transmit the request to the UE 115a and/or UE 115b via a radio resource control (RRC) communication, downlink control information (DCI), a medium access control control element (MAC-CE), a physical downlink control channel (PDCCH) communication, a physical downlink shared channel (PDSCH) communication, or other suitable communication. In some aspects, the network unit may aperiodically transmit the request to the UE 115a and/or UE 115b via a broadcast message, a groupcast message, and/or a unicast message. In response to receiving the request, the UE 115a and/or UE 115b may transmit the measurements of the first reference signal(s) and/or the measurements of the second reference signal(s) to the network unit 105. In some aspects, the network unit 105 may transmit a configuration (e.g., a configured grant) to the UE 115a and/or UE 115b indicating the time resources and/or frequency resources the UE 115a and/or UE 115b may use to transmit the measurements to the network unit 105.

In some aspects, the network unit 105 may receive the measurements of the first and/or second reference signal(s) from the UE 115a and/or UE 115b via uplink control information (UCI), a physical uplink control channel (PUCCH) communication, a physical uplink shared channel (PUSCH) communication, or other suitable communication.

In some aspects, the network unit 105 may receive measurements of the first reference signal(s) and/or second reference signal(s) indicated in measurement units. For example, the measurement units may include a power level, a decibel level, a ratio, an angle (AOA), a covariance matrix, an index value, or other suitable measurement units. The network unit 105 may receive the measurements in measurement units and compare the measurements by determining whether a difference between at least one of the measurements of the first reference signal(s) and at least one of the measurements of the second reference signal(s) satisfies a threshold (e.g., greater than or equal to the threshold).

Additionally or alternatively, the network unit 105 may receive an indicator from the UE 115a and/or UE 115b indicating the comparison of the measurements of the first reference signal(s) with the measurements of the second reference signal(s). For example, the UE 115a and/or UE 115b may compare the measurements by determining whether a difference between at least one of the measurements of the first reference signal(s) and at least one of the measurements of the second reference signal(s) satisfies a threshold. The network unit 105 may receive an indicator indicating whether the difference satisfies the threshold. For example, the network unit 105 may receive a binary value of “1” indicating the difference satisfies the threshold or a binary value of “0” indicating the difference does not satisfy the threshold. Additionally or alternatively, the network unit 105 may receive a binary value of “0” indicating the difference satisfies the threshold or a binary value of “1” indicating the difference does not satisfy the threshold.

In some aspects, the network unit 105 may receive measurements of the first reference signal(s) indicated as an average of the measurements of the first reference signal(s). In some aspects, the network unit 105 may receive measurements of the second reference signal(s) indicated as an average of the measurements of the second reference signal(s). In this regard, the UE 115a and/or UE 115b may perform measurements of the first reference signal(s) and/or second reference signal(s) over a time period. The time period may be a number of symbols, a number of slots, a number of frames, a number of subframes, a number of milliseconds or other suitable time period. The UEs may determine (e.g., compute) an average of the measurements of the first reference signal(s) and/or second reference signal(s) over the time period. The network unit 105 may receive the average of the measurements via UCI, a PUCCH communication, a PUSCH communication, or other suitable communication. The network unit 105 may receive the average of the measurements in measurement units and compare the average of the measurements by determining whether a difference between at least one of the average measurements of the first reference signal(s) and at least one of the average measurements of the second reference signal(s) satisfies a threshold.

In some aspects, the UE 115a and/or UE 115b may be geographically distributed. In this regard, the UE 115a and/or UE 115b may be geographically distributed across different geographic zones 450 and/or 452 (e.g., different geographic areas). The zones 450 and/or 452 may be partially overlapping or non-overlapping. The network unit 105 may transmit a zone identifier (ID) to the UE 115a indicating the UE 115a is located in zone 450. The network unit 105 may transmit a zone ID to the UE 115b indicating the UE 115a is located in zone 452. The network unit 105 may determine which zone 450 and/or 452 the UE 115a and/or UE 115b are in based on receiving GPS coordinates from the UE 115a and/or UE 115b, radio frequency triangulation, or other suitable positioning method. In some aspects, the network unit 105 may update the zone IDs based on the mobility of the UE 115a and/or UE 115b. For example, the network unit 105 may transmit an updated zone ID to the UE 115a and/or UE 115b when the network unit detects that the UE 115a and/or UE 115b moved from one zone to another zone.

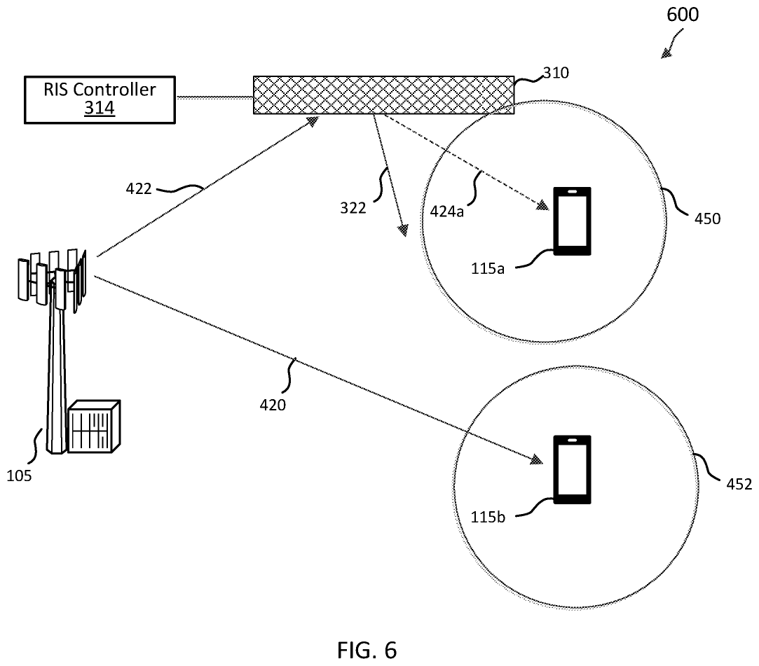

FIG. 6 illustrates reference signal transmission in zones of a wireless communication network 600 according to some aspects of the present disclosure. The RIS 310 may be configured by the network unit 105 to reflect the reference signal(s) in a direction 424a towards the UE 115a. In the illustration of FIG. 6, the RIS 310 is shown reflecting a reference signal in an unintended direction 322. The RIS 310 may reflect the signal in an unintended direction 322 based on the RIS controller 314 being hacked and/or compromised. In this regard, the measurements of the second reference signal(s) may be compared to the first reference signal measurements as a check to determine if the RIS 310 is still operating according to the configuration set by the network unit 105.

In some aspects, the network unit may detect the unintended signal reflection based on the covariance matrix:

$$Gi ΦΦ attack H - Gi Φ H$$

Where Gi represents the channel between the RIS and the UE, Φ is a square matrix of a size based on the number of RIS elements and represents the RIS configuration set by the network unit (intended reflections), H represents the channel between the network unit and the RIS, and Φattack represents the unintended signal reflections.

The check to determine if the RIS 310 is still operating according to the configuration may be done on a periodic basis. In some aspects, the RIS 310 operational check may be triggered by an event. For example, the event may include the network unit 105 receiving a message requesting to perform the RIS 310 operational check, the network unit 105 may detect one or more radio link failures, or other suitable event. If the comparison of the first reference signal measurements with the second reference signal measurements indicates a difference over a threshold, the RIS 310 (e.g., a portion of the RIS) may not be operating according to the configuration (e.g., the reference signal(s) are reflected in an unintended direction 322). In some aspect, the RIS 310 may not be operating according to the set configuration based on the RIS controller 314 being hacked in a denial of service attack.

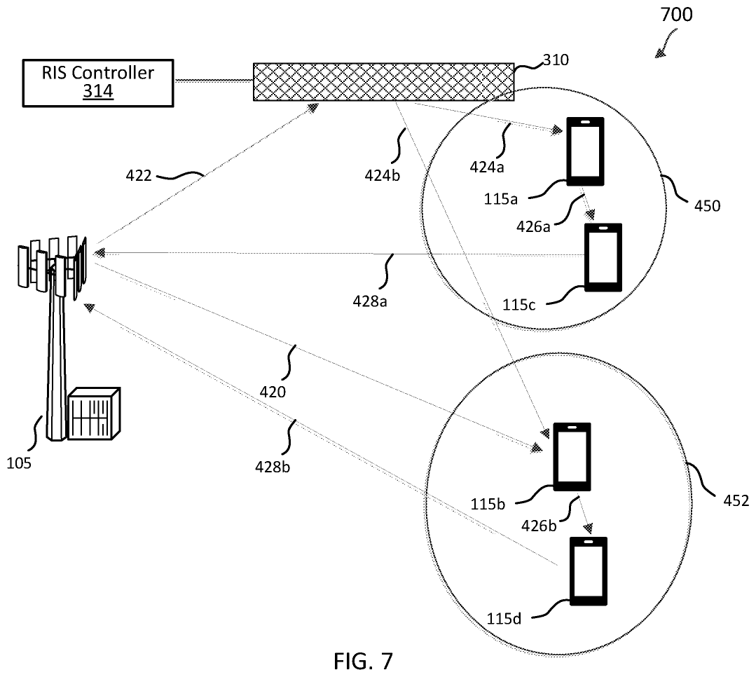

FIG. 7 illustrates master nodes UE 115c and UE 115d in zones 450 and 452 of a wireless communication network 700 according to some aspects of the present disclosure. In some aspects, the network unit 105 may receive the measurements of the first reference signal(s) and/or the measurements of the second reference signal(s) from a master node UE 115c and/or UE 115d. In some aspects, one or more zones may include one or more master node UEs. For example, the master node UE 115c may receive the measurements of the first reference signal(s) and/or the second reference signal(s) from the UE 115a over link 426a (e.g., a sidelink) within zone 450 that includes the master node UE 115c and the UE 115a. The master node UE 115d may receive the measurements of the first reference signal(s) and/or the second reference signal(s) from the UE 115b over link 426b (e.g., a sidelink) within zone 452 that includes the master node UE 115d and the UE 115b. The master node UE 115c and/or UE 115d may collect the measurements and transmit (e.g., relay, forward) the measurements to the network unit 105. For example, the master node UE 115c may receive the measurements from the UE 115a and transmit the measurements to the network unit in direction 428a. The master node UE 115c may receive the measurements from the UE 115b and transmit the measurements to the network unit in direction 428b.

In some aspects, the master node UE 115c and/or UE 115d may receive the measurements from the UE 115a and/or UE 115b as measurement units (e.g., power level, a decibel level, a ratio, an angle (AOA), a covariance matrix, an index value), an average of measurement units, an indicator (e.g., binary indicator) indicating the comparison of the measurements, or a combination thereof. The master node UE 115c and/or UE 115d may transmit the measurements to the network unit 105 as measurement units, an average of measurement units, an indicator (e.g., binary indicator) indicating the comparison of the measurements, or a combination thereof. For example, the network unit 105 may receive an indicator from the master node UE 115c and/or UE 115d indicating the comparison of the measurements of the first reference signal(s) with the measurements of the second reference signal(s). For example, the master node UE 115c and/or UE 115d may compare the measurements by determining whether a difference between at least one of the measurements of the first reference signal(s) and at least one of the measurements of the second reference signal(s) satisfies a threshold. If the master node UE 115c and/or UE 115d is out of coverage of the network unit 105, the master node UE 115c and/or UE 115d may use another master node UE or the UE 115 to relay the measurements to the network unit 105. For example, the master node UE 115c and/or UE 115d may transmit the measurements via a sidelink communication to one or more master node UEs or the UE 115 to relay the measurements to the network unit 105. In some aspects, the master node UE may include a programmable logic controller, a hub, a router, a smartphone, or other suitable electronic device.

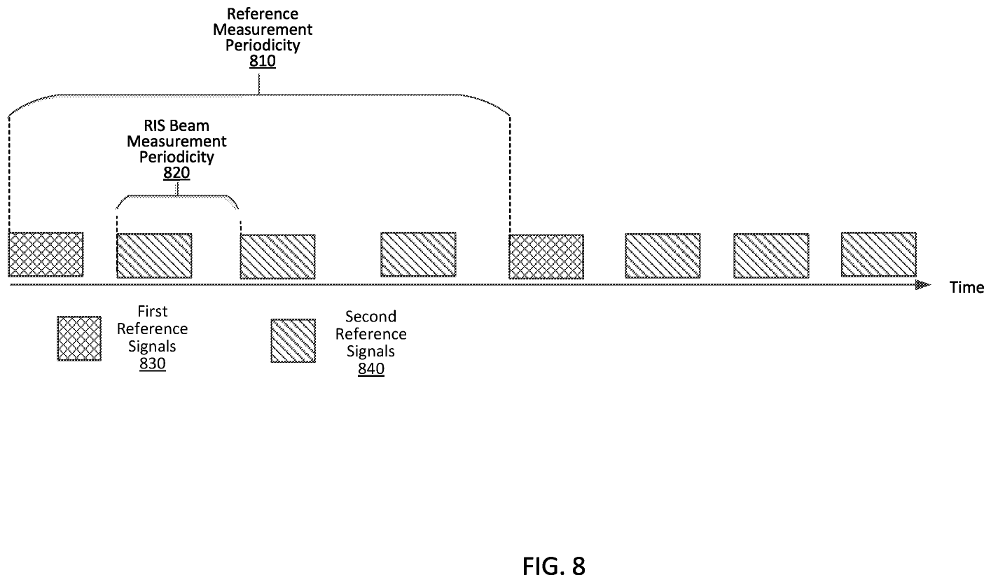

FIG. 8 illustrates timing of reference signal transmission in a wireless communication network according to some aspects of the present disclosure. In some aspects, the network unit may transmit the first reference signal(s) 830 at the reference measurement periodicity 810. The network unit may transmit the second reference signal(s) 840 at the RIS beam measurement periodicity 820. The RIS beam measurement periodicity 820 may be a multiple (e.g., an integer multiple) of the reference measurement periodicity 810. For example, the network unit may transmit the first reference signal(s) 830 every x time periods. The time period may be a number of symbols, a number of slots, a number of frames, a number of subframes, a number of milliseconds or other suitable time period. The network unit may transmit the second reference signal(s) 840 every xy time periods, where y is an integer. In some aspects, the measurements associated with the first reference signal(s) 830 may represent a baseline set of measurements. The UEs may perform the baseline measurements at the reference measurement periodicity 810. When the UEs perform reference signal measurements to gain a baseline measurement, the new baseline measurements may replace the previous baseline measurements. When the first reference signal(s) 830 are transmitted by the network unit to the UEs via the RIS, the RIS may be in an intended operating condition in which the RIS reflects the reference signal(s) according to a configuration set by the network unit. The RIS may reflect the reference signal(s) in an intended direction according to the configuration set by the network unit. Aspects of the present disclosure may determine when the reference signal(s) are reflected in an unintended direction based on a comparison of the measurements of the first reference signal(s) with measurements of one or more second reference signal(s).

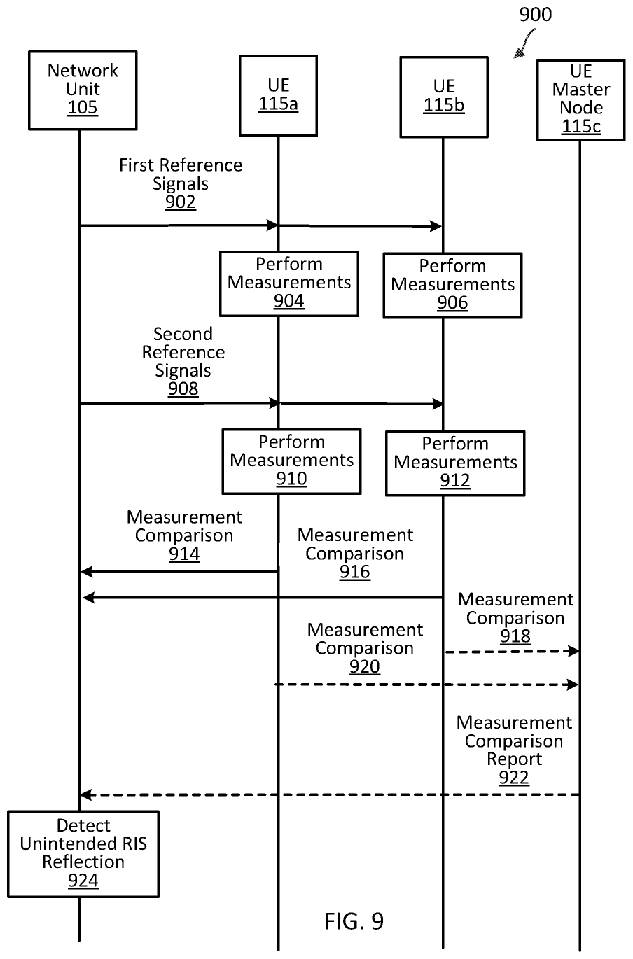

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the actions. For example, a wireless communication device, such as the UE 115, the UE 1000, and the BS 105, the RU 240, the DU 230, the CU 210, and/or the network unit 1100, may utilize one or more components, such as the processor 1102, the memory 1104, the RIS detection module 1108, the transceiver 1110, the modem 1112, and the one or more antennas 1116, to execute aspects of method 900. The method 900 may employ similar mechanisms as in the networks 100 and 200 and the aspects and actions described with respect to FIGS. 3-8. As illustrated, the method 900 includes a number of enumerated actions, but the method 900 may include additional actions before, after, and in between the enumerated actions. In some aspects, one or more of the enumerated actions may be omitted or performed in a different order.

At action 902, the method 900 includes the network unit 105 transmitting one or more first reference signal(s) to the UE 115a and/or the UE 115b. The first reference signal(s) may include a synchronization signal block (SSB), a primary synchronization signal (PSS), a secondary synchronization signal (SSS), a cell specific reference signal (CRS), a demodulation reference signal (DMRS), a channel state information reference signal (CSI-RS), a phase tracking reference signal (PTRS), and/or other suitable reference signal. In some aspects, the network unit 105 may transmit the first reference signal(s) using a transmit beam, a transmit port, and a RIS configuration. The transmit beam may include a direction in which the first reference signal(s) are transmitted by the network unit. In some aspects, the network unit 105 may transmit the first reference signal(s) in a direction towards the RIS. The network unit 105 may transmit the first reference signal(s) in a direction towards the RIS such that the RIS reflects the reference signal(s) in a direction towards the UE 115a and/or the UE 115b.

At action 904, the UE 115a may measure one or more parameters associated with the first reference signal(s). In this regard, the measurements of the first reference signal(s) may include at least one of a reference signal received power (RSRP) associated with the first reference signal(s), a reference signal received quality (RSRQ) associated with the first reference signal(s), a signal to interference and noise ratio (SINR) associated with the first reference signal(s), a covariance matrix associated with the first reference signal(s), an angle of arrival (AoA) associated with the first reference signal(s), and/or other suitable parameters.

At action 906, the UE 115b may measure one or more parameters associated with the first reference signal(s). In this regard, the measurements of the first reference signal(s) may include at least one of a reference signal received power (RSRP) associated with the first reference signal(s), a reference signal received quality (RSRQ) associated with the first reference signal(s), a signal to interference and noise ratio (SINR) associated with the first reference signal(s), a covariance matrix associated with the first reference signal(s), an angle of arrival (AoA) associated with the first reference signal(s), and/or other suitable parameters.

At action 908, the method 900 includes the network unit 105 transmitting one or more second reference signal(s) to the UE 115a and/or the UE 115b. The second reference signal(s) may include a SSB, a PSS, a SSS, a CRS, a DMRS, a CSI-RS, a PTRS, and/or other suitable reference signal(s). In some aspects, the second reference signal(s) may be the same or different type of reference signal(s) as the first reference signal(s). In some aspects, the network unit 105 may transmit the second reference signal(s) to the UE 115a and/or the UE 115b via the RIS. In some aspects, the network unit 105 may transmit the second reference signal(s) using the same transmit beam, same transmit port, and same RIS configuration as the first reference signal(s) transmitted by the network unit 105 at action 902. In some instances, the network unit 105 may transmit the second reference signal(s) using the same transmit beam, same transmit port, and same RIS configuration as the first reference signal(s) in order to facilitate a comparison of measurements between the first and second reference signal(s) based on the same reference signal configuration.

At action 910, the method 900 includes the UE 115a measuring the second reference signals. The UE 115a may perform the same measurements as those performed on the first reference signal measurements. In this regard, the measurements of the second reference signal(s) may include at least one of a RSRP associated with the second reference signal(s), a RSRQ associated with the second reference signal(s), a SINR associated with the second reference signal(s), a covariance matrix associated with the second reference signal(s), an AoA associated with the second reference signal(s), and/or other suitable parameter(s).

At action 912, the method 900 includes the UE 115b measuring the second reference signals. The UE 115b may perform the same measurements as those performed on the first reference signal measurements. In this regard, the measurements of the second reference signal(s) may include at least one of a RSRP associated with the second reference signal(s), a RSRQ associated with the second reference signal(s), a SINR associated with the second reference signal(s), a covariance matrix associated with the second reference signal(s), an AoA associated with the second reference signal(s), and/or other suitable parameter(s).

At action 914, the method 900 includes the UE 115a transmitting the measurements and/or an indicator of the measurements to the network unit 105. The UE 115a may transmit the measurements in uplink control information (UCI), a physical uplink control channel (PUCCH) communication, a physical uplink shared channel (PUSCH) communication, or other suitable communication. The network unit 105 may transmit an indicator (e.g., a configured grant) to the UE 115a indicating time resources and/or frequency resources via which the UE 115a may transmit the measurements to the network unit 105.

At action 916, the method 900 includes the UE 115b transmitting the measurements and/or an indicator of the measurements to the network unit 105. The UE 115b may transmit the measurements in uplink control information (UCI), a physical uplink control channel (PUCCH) communication, a physical uplink shared channel (PUSCH) communication, or other suitable communication. The network unit 105 may transmit an indicator (e.g., a configured grant) to the UE 115b indicating time resources and/or frequency resources via which the UE 115b may transmit the measurements to the network unit 105.

At action 918, the method 900 additionally or alternatively includes the UE 115b transmitting the measurements and/or an indicator of the measurements to the UE master node 115c. In this regard, the UE 115b may transmit the measurements and/or an indicator of the measurements to the UE master node 115c via a sidelink communication or any suitable communication.

At action 920, the method 900 additionally or alternatively includes the UE 115a transmitting the measurements and/or an indicator of the measurements to the UE master node 115c. In this regard, the UE 115a may transmit the measurements and/or an indicator of the measurements to the UE master node 115c via a sidelink communication or any suitable communication.

At action 922, the method 900 includes the UE master node 115c transmitting a measurement comparison report to the network unit 105. In some aspects, the master node UE 115c may receive the measurements from the UE 115a and/or UE 115b as measurement units (e.g., power level, a decibel level, a ratio, an angle (AOA), a covariance matrix, an index value), an average of measurement units, an indicator (e.g., binary indicator) indicating the comparison of the measurements, or a combination thereof. The master node UE 115c may transmit the measurements to the network unit 105 as measurement units, an average of measurement units, an indicator (e.g., binary indicator) indicating the comparison of the measurements, or a combination thereof. For example, the network unit 105 may receive an indicator from the master node UE 115c indicating the comparison of the measurements of the first reference signal(s) with the measurements of the second reference signal(s). For example, the master node UE 115c may compare the measurements by determining whether a difference between at least one of the measurements of the first reference signal(s) and at least one of the measurements of the second reference signal(s) satisfies a threshold. If the master node UE 115c is out of coverage of the network unit 105, the master node UE 115c may use another master node UE or a UE 115 to relay the measurements to the network unit 105. For example, the master node UE 115c may transmit the measurements via a sidelink communication to one or more master node UEs or UEs to relay the measurements to the network unit 105. In some aspects, the master node UE 115c may include a programmable logic controller, a hub, a router, a smartphone, or other suitable electronic device.

At action 924, the method 900 includes the network unit 105 detecting an unintended signal reflection associated with the RIS. The network unit 105 may detect the unintended signal reflection based on a comparison of measurements associated with the one or more first reference signal(s) with measurements associated with the one or more second reference signal(s). In this regard, detecting the unintended signal reflection associated with the RIS may include detecting a hack and/or interference associated with a controller of the RIS. The RIS may include a controller (e.g., a microcontroller, a processor 1002, a processor 1102, a field programmable gate array, or other suitable controller) that controls the elements and operation of the RIS. For example, the network unit 105 may transmit a configuration to the RIS controller to set the reflection angle of the RIS. The RIS controller may set the reflection angle based on the configuration from the network unit. In some aspects, the RIS controller may be hacked and/or otherwise interfered with (e.g., intentionally or unintentionally by a third party) such that the reflection angle of the RIS (e.g., a portion of the RIS, a subset of elements of the RIS) is changed from the network unit 105 setting thereby causing unintended signal reflections. In some aspect, the hack and/or interference may include a malicious hack intended to cause a denial of service.

In some aspects, the network unit may detect the unintended signal reflection based on the covariance matrix:

$$Gi ΦΦ attack H - Gi Φ H$$

Where Gi represents the channel between the RIS and the UE, Φ is a square matrix of a size based on the number of RIS elements and represents the RIS configuration set by the network unit (intended reflections), H represents the channel between the network unit and the RIS, and Φattack represents the unintended signal reflections.

In response to detecting the unintended signal reflection associated with the RIS, the network unit 105 may perform one or more remedial actions. In some aspects, the network unit 105 may attempt to reconfigure the RIS to reflect signals in the intended direction. The network unit 105 may retransmit the configuration setting to the RIS controller, request additional reference signal measurements from the UEs to perform additional detection methods, transmit a command to the RIS controller to turn off power to the RIS, transmit a command to the RIS controller to disable a portion (e.g., a cluster of elements) of the RIS in which the unintended signal reflection was detected, or other suitable remedial action.

In some aspects, the network unit 105 may detect the unintended signal reflection associated with the RIS based on a probability that the RIS is reflecting signals in an unintended direction. The network unit 105 may detect the unintended signal reflection when the probability satisfies a threshold (e.g., greater than or equal to the threshold). The probability may be determined based on the number of UEs that indicate a difference between the measurements of the first and second reference signal(s) satisfies a threshold (e.g., greater than and/or equal to the threshold). For example, when a threshold number of UEs (e.g., a raw number of UEs and/or a percentage of UEs) in a zone indicate a difference between the measurements of the first and second reference is greater than and/or equal to the threshold, the network unit 105 may consider an unintended signal reflection as having been detected. As another example, when one or more UEs (e.g., a raw number of UEs and/or a percentage of UEs) in a zone indicate a threshold number of comparisons (e.g., a raw number of comparisons and/or a percentage of comparisons) over time indicate a difference between the measurements of the first and second reference is greater than and/or equal to the threshold, the network unit 105 may consider an unintended signal reflection as having been detected.

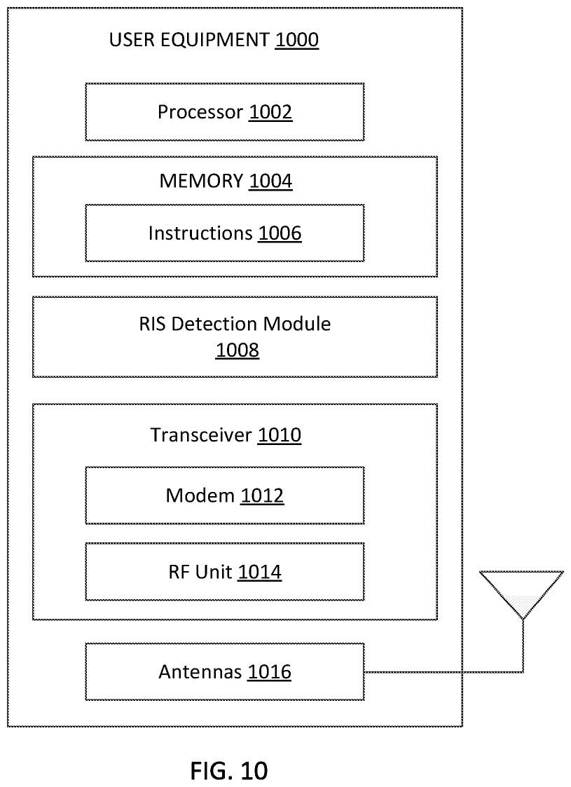

FIG. 10 is a block diagram of an exemplary UE 1000 according to some aspects of the present disclosure. The UE 1000 may be the UE 115 in the network 100, 200, or 300 as discussed above. As shown, the UE 1000 may include a processor 1002, a memory 1004, a RIS detection module 1008, a transceiver 1010 including a modem subsystem 1012 and a radio frequency (RF) unit 1014, and one or more antennas 1016. These elements may be coupled with each other and in direct or indirect communication with each other, for example via one or more buses.

The processor 1002 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 1004 includes a non-transitory computer-readable medium. The memory 1004 may store instructions 1006. The instructions 1006 may include instructions that, when executed by the processor 1002, cause the processor 1002 to perform the operations described herein with reference to the UEs 115 in connection with aspects of the present disclosure, for example, aspects of FIGS. 3, 4A and 4B. Instructions 1006 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The RIS detection module 1008 may be implemented via hardware, software, or combinations thereof. For example, the RIS detection module 1008 may be implemented as a processor, circuit, and/or instructions 1006 stored in the memory 1004 and executed by the processor 1002. In some aspects, the RIS detection module 1008 may implement the aspects of FIGS. 3-9. For example, the RIS detection module 1008 may receive, from a network unit, one or more first reference signals associated with a reconfigurable intelligent surface (RIS). The RIS detection module 1008 may receive, from the network unit, one or more second reference signals associated with the RIS. The RIS detection module 1008 may transmit an indicator indicating a comparison of first measurements associated with the one or more first reference signals with second measurements associated with the one or more second reference signals.

As shown, the transceiver 1010 may include the modem subsystem 1012 and the RF unit 1014. The transceiver 1010 can be configured to communicate bi-directionally with other devices, such as the BSs 105 and/or the UEs 115. The modem subsystem 1012 may be configured to modulate and/or encode the data from the memory 1004 and the according to a modulation and coding scheme (MCS), e.g., a low-density parity check (LDPC) coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data from the modem subsystem 1012 (on outbound transmissions) or of transmissions originating from another source such as a UE 115 or a BS 105. The RF unit 1014 may be further configured to perform analog beamforming in conjunction with the digital beamforming. Although shown as integrated together in transceiver 1010, the modem subsystem 1012 and the RF unit 1014 may be separate devices that are coupled together to enable the UE 1000 to communicate with other devices.

The RF unit 1014 may provide the modulated and/or processed data, e.g. data packets (or, more generally, data messages that may contain one or more data packets and other information), to the antennas 1016 for transmission to one or more other devices. The antennas 1016 may further receive data messages transmitted from other devices. The antennas 1016 may provide the received data messages for processing and/or demodulation at the transceiver 1010. The antennas 1016 may include multiple antennas of similar or different designs in order to sustain multiple transmission links. The RF unit 1014 may configure the antennas 1016.

In some instances, the UE 1000 can include multiple transceivers 1010 implementing different RATs (e.g., NR and LTE). In some instances, the UE 1000 can include a single transceiver 1010 implementing multiple RATs (e.g., NR and LTE). In some instances, the transceiver 1010 can include various components, where different combinations of components can implement RATs.

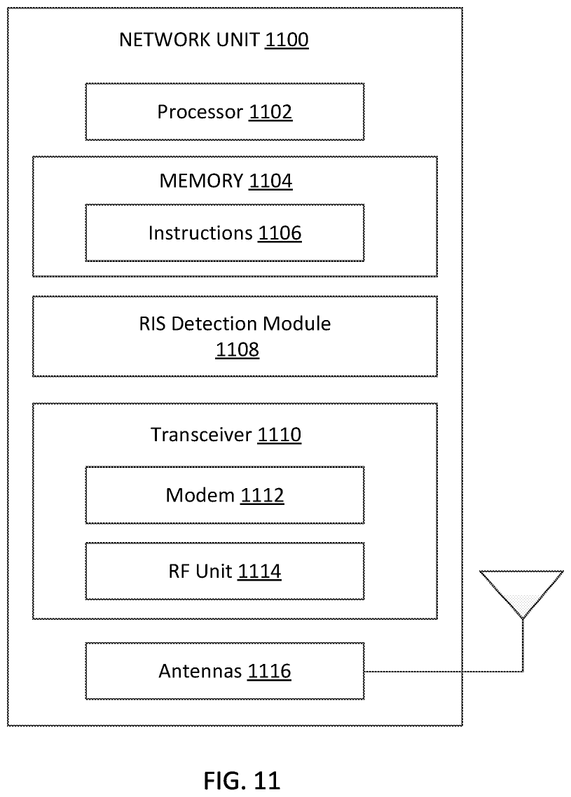

FIG. 11 is a block diagram of an exemplary network unit 1100 according to some aspects of the present disclosure. The network unit 1100 may be the BS 105, the CU 210, the DU 230, or the RU 240, as discussed above. As shown, the network unit 1100 may include a processor 1102, a memory 1104, a RIS detection module 1108, a transceiver 1110 including a modem subsystem 1112 and a RF unit 1114, and one or more antennas 1116. These elements may be coupled with each other and in direct or indirect communication with each other, for example via one or more buses.

The processor 1102 may have various features as a specific-type processor. For example, these may include a CPU, a DSP, an ASIC, a controller, a FPGA device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 1104 may include a non-transitory computer-readable medium. The memory 1104 may store instructions 1106. The instructions 1106 may include instructions that, when executed by the processor 1102, cause the processor 1102 to perform operations described herein, for example, aspects of FIGS. 3-9. Instructions 1106 may also be referred to as code, which may be interpreted broadly to include any type of computer-readable statement(s).

The RIS detection module 1108 may be implemented via hardware, software, or combinations thereof. For example, the RIS detection module 1108 may be implemented as a processor, circuit, and/or instructions 1106 stored in the memory 1104 and executed by the processor 1102.

In some aspects, the RIS detection module 1108 may implement the aspects of FIGS. 3-9. For example, the RIS detection module 1108 may transmit, to one or more user equipment (UEs), one or more first reference signals. The RIS detection module 1108 may transmit, to the one or more UEs, one or more second reference signals. The RIS detection module 1108 may detect an unintended signal reflection associated with a reconfigurable intelligent surface (RIS) based on a comparison of first measurements associated with the one or more first reference signals with second measurements associated with the one or more second reference signals.

Additionally or alternatively, the RIS detection module 1108 can be implemented in any combination of hardware and software, and may, in some implementations, involve, for example, processor 1102, memory 1104, instructions 1106, transceiver 1110, and/or modem 1112.

As shown, the transceiver 1110 may include the modem subsystem 1112 and the RF unit 1114. The transceiver 1110 can be configured to communicate bi-directionally with other devices, such as the UEs 115 and/or 1000. The modem subsystem 1112 may be configured to modulate and/or encode data according to a MCS, e.g., a LDPC coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data from the modem subsystem 1112 (on outbound transmissions) or of transmissions originating from another source such as a UE 115 or UE 1000. The RF unit 1114 may be further configured to perform analog beamforming in conjunction with the digital beamforming. Although shown as integrated together in transceiver 1110, the modem subsystem 1112 and/or the RF unit 1114 may be separate devices that are coupled together at the network unit 1100 to enable the network unit 1100 to communicate with other devices.

The RF unit 1114 may provide the modulated and/or processed data, e.g. data packets (or, more generally, data messages that may contain one or more data packets and other information), to the antennas 1116 for transmission to one or more other devices. This may include, for example, a configuration indicating a plurality of sub-slots within a slot according to aspects of the present disclosure. The antennas 1116 may further receive data messages transmitted from other devices and provide the received data messages for processing and/or demodulation at the transceiver 1110. The antennas 1116 may include multiple antennas of similar or different designs in order to sustain multiple transmission links.

In some instances, the network unit 1100 can include multiple transceivers 1110 implementing different RATs (e.g., NR and LTE). In some instances, the network unit 1100 can include a single transceiver 1110 implementing multiple RATs (e.g., NR and LTE). In some instances, the transceiver 1110 can include various components, where different combinations of components can implement RATs.

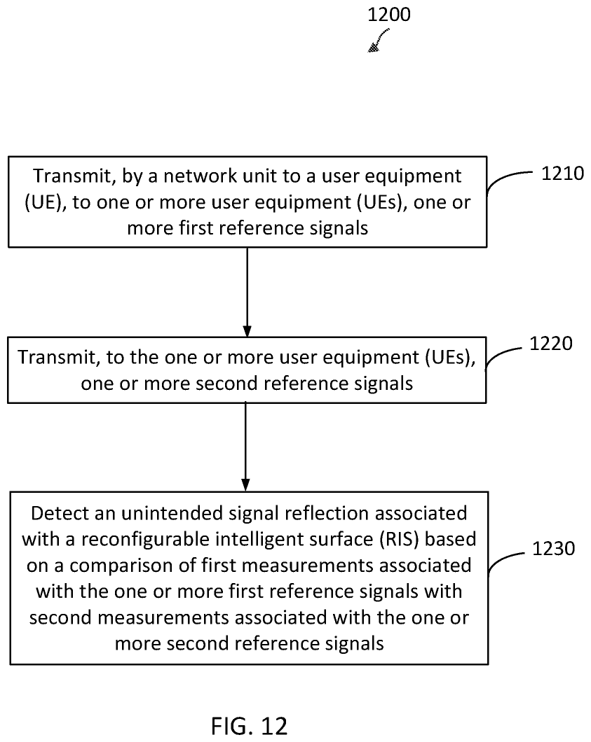

FIG. 12 is a flow diagram of a communication method 1200 according to some aspects of the present disclosure. Aspects of the method 1200 can be executed by a computing device (e.g., a processor, processing circuit, and/or other suitable component) of a wireless communication device or other suitable means for performing the actions. For example, a wireless communication device, such as the BS 105, the RU 240, the DU 230, the CU 210, and/or the network unit 1100, may utilize one or more components, such as the processor 1102, the memory 1104, the RIS detection module 1108, the transceiver 1110, the modem 1112, and the one or more antennas 1116, to execute aspects of method 1200. The method 1200 may employ similar mechanisms as in the networks 100 and 200 and the aspects and actions described with respect to FIGS. 3-9. As illustrated, the method 1200 includes a number of enumerated actions, but the method 1200 may include additional actions before, after, and in between the enumerated actions. In some aspects, one or more of the enumerated actions may be omitted or performed in a different order.

At action 1210, the method 1200 includes a network unit (e.g., the network unit 1100, the BS 105, the RU 240, the DU 230, and/or the CU 210) transmitting one or more first reference signal(s) to one or more user equipment (UEs) (e.g., the UE 115, the UE 1000). The first reference signal(s) may include a synchronization signal block (SSB), a primary synchronization signal (PSS), a secondary synchronization signal (SSS), a cell specific reference signal (CRS), a demodulation reference signal (DMRS), a channel state information reference signal (CSI-RS), a phase tracking reference signal (PTRS), and/or other suitable reference signal. For example, when the network unit operates in a new radio (NR) mode, the reference signal may include a synchronization signal block (SSB), a primary synchronization signal (PSS), and/or a secondary synchronization signal (SSS), a demodulation reference signal (DMRS), a channel state information reference signal (CSI-RS), or a phase tracking reference signal (PTRS). When the network unit operates in a long term evolution (LTE) mode, the reference signal may include a cell specific reference signal (CRS).

In some aspects, the network unit may directly transmit the first reference signal(s) to the UEs. Additionally or alternatively, the network unit may transmit the first reference signal(s) to the UEs via a reconfigurable intelligent surface (RIS) (e.g., the RIS 310 of FIGS. 3-7). In some aspects, the RIS may be deployed to control one or more channels and/or signal propagation paths between the network unit and the UEs. The RIS may control the channel(s) and/or signal propagation path(s) by reflecting, forming, and/or modulating the radio signals from the network unit to the UEs and/or from the UEs to the network unit. That is, in some instances the RIS may modify an incident radio signal waveform in a controlled manner to enhance and/or improve channel diversities. Increasing channel diversities may provide robustness to channel blocking and/or fading, which may be particularly useful for mmWave communications and other communications. The transmitted (e.g., incident) first reference signal(s) may be reflected by the RIS by adjusting phase shifts that constructively interfere and/or steer the reflected reference signal(s) towards the UEs in order to effectively control multi-path effects. In some instances, the RIS may steer the reflected reference signal(s) through 3-dimensional passive beamforming, thereby improving spectrum and/or energy efficiency. The RIS may be configured to forward (e.g., reflect) a more efficient phase-shifted version of the incident reference signal(s) and/or shape channel propagation to adapt against channel variations due to unpredictable wireless environments.

In some aspects, the network unit may transmit the first reference signal(s) using a transmit beam, a transmit port, and a RIS configuration. The transmit beam may include a direction in which the first reference signal(s) are transmitted by the network unit. For example, referring to FIG. 3, the network unit may transmit the first reference signal(s) in a direction 420 towards the UEs (e.g., a geographic zone 450 and/or 452 that includes the UEs). Additionally or alternatively, the network unit may transmit the first reference signal(s) in a direction 422 towards the RIS. The network unit may transmit the first reference signal(s) in a direction 422 towards the RIS such that the RIS reflects the reference signal(s) in a direction 424 towards the UEs (e.g., a geographic zone 450 and/or 452 that includes the UEs).

The transmit beam may further include a beam width. For example, the network unit may transmit the first reference signal(s) using a wide beam width covering a wide area and/or a narrow beam width concentrating the reference signal(s) into a narrow area. The transmit port may indicate the antenna port(s) of the network unit used to transmit the first reference signal(s). The RIS configuration may include a configuration transmitted by the network unit to a control unit of the RIS (e.g., RIS controller). The RIS configuration may include the parameters to be used by the RIS when the first reference signal(s) are reflected towards the UEs. The parameters of the RIS configuration may include angle of reflection, signal amplitude changes, signal polarization changes, signal phase changes, and/or other suitable RIS parameters.

In some aspects, the UEs may measure one or more parameters associated with the first reference signal(s). In this regard, the measurements of the first reference signal(s) may include at least one of a reference signal received power (RSRP) associated with the first reference signal(s), a reference signal received quality (RSRQ) associated with the first reference signal(s), a signal to interference and noise ratio (SINR) associated with the first reference signal(s), a covariance matrix associated with the first reference signal(s), an angle of arrival (AoA) associated with the first reference signal(s), and/or other suitable parameters.

In some aspects, the network unit may transmit the first reference signal(s) at a first periodicity (e.g., the reference measurement periodicity 810) and transmit the second reference signal(s) at a second periodicity (e.g., the RIS beam measurement periodicity 820). The second periodicity may be a multiple (e.g., an integer multiple) of the first periodicity. For example, the network unit may transmit the first reference signal(s) every x time periods. The time period may be a number of symbols, a number of slots, a number of frames, a number of subframes, a number of milliseconds or other suitable time period. The network unit may transmit the second reference signal(s) every xy time periods, where y is an integer. In some aspects, the measurements associated with the first reference signal(s) may represent a baseline set of measurements. The UEs may perform the measurements periodically. For example, the UEs may perform the measurements at the reference measurement periodicity 810 as shown in FIG. 8. When the UEs perform reference signal measurements to gain a baseline measurement, the new baseline measurements replace the previous baseline measurements. When the first reference signal(s) are transmitted by the network unit to the UEs via the RIS, the RIS may be in an operating condition in which the RIS reflects the reference signal(s) according to a configuration set by the network unit. The RIS may reflect the reference signal(s) in an intended direction according to the configuration set by the network unit. Aspects of the present disclosure may determine when the reference signal(s) are reflected in an unintended direction based on a comparison of the measurements of the first reference signal(s) with measurements of one or more second reference signal(s) as described in detail below.

At action 1220, the method 1200 includes the network unit transmitting one or more second reference signal(s) to the one or more UEs. The second reference signal(s) may include a SSB, a PSS, a SSS, a CRS, a DMRS, a CSI-RS, a PTRS, and/or other suitable reference signal(s). In some aspects, the second reference signal(s) may be the same or different type of reference signal(s) as the first reference signal(s).

In some aspects, the network unit may transmit the second reference signal(s) to the UEs via the RIS. In some aspects, the network unit may transmit the second reference signal(s) using the same transmit beam, same transmit port, and same RIS configuration as the first reference signal(s) transmitted by the network unit at action 1210. In some instances, the network unit may transmit the second reference signal(s) using the same transmit beam, same transmit port, and same RIS configuration as the first reference signal(s) in order to facilitate a comparison of measurements between the first and second reference signal(s) based on the same reference signal configuration.

In some aspects, the UEs may measure one or more parameter(s) associated with the second reference signal(s). The UEs may perform the same measurements as those performed on the first reference signal measurements. In this regard, the measurements of the second reference signal(s) may include at least one of a RSRP associated with the second reference signal(s), a RSRQ associated with the second reference signal(s), a SINR associated with the second reference signal(s), a covariance matrix associated with the second reference signal(s), an AoA associated with the second reference signal(s), and/or other suitable parameter(s).

A comparison of the measurements of the first reference signal(s) with the measurements of the second reference signal(s) may be used to determine if the RIS is operating according to a configuration set by the network unit. When the first reference signal(s) are transmitted by the network unit to the UEs via the RIS, the RIS may be in an operating condition in which the RIS reflects the reference signal(s) according to the configuration set by the network unit. The RIS may reflect the reference signal(s) in an intended direction according to the configuration set by the network unit. The measurements of the second reference signal(s) may occur after the first reference signal measurements (e.g., the baseline measurements) and over one or more times (e.g., periodically). The measurements of the second reference signal(s) may be compared to the first reference signal measurements as a check to determine if the RIS is still operating according to the configuration. The check to determine if the RIS is still operating according to the configuration may be done on a periodic basis. For example, the RIS operational check may be performed at the reference measurement periodicity 810, the RIS beam measurement periodicity 820, or other suitable periodicity. In some aspects, the RIS operational check may be triggered by an event. For example, the event may include the network unit receiving a message requesting to perform the RIS operational check, the network unit may detect one or more radio link failures, or other suitable event. If the comparison of the first reference signal measurements with the second reference signal measurements indicates a difference over a threshold, the RIS (e.g., a portion of the RIS) may not be operating according to the configuration (e.g., the reference signal(s) are reflected in an unintended direction). In some aspect, the RIS may not be operating according to the set configuration based on the RIS controller being hacked.

Additionally or alternatively, the network unit may transmit a request to the UEs for the measurements of the first reference signal(s) and/or the measurements of the second reference signal(s). In this regard, the network unit may periodically and/or aperiodically transmit the request to the UEs via a radio resource control (RRC) communication, downlink control information (DCI), a medium access control control element (MAC-CE), a physical downlink control channel (PDCCH) communication, a physical downlink shared channel (PDSCH) communication, or other suitable communication. In some aspects, the network unit may aperiodically transmit the request to the UEs via a broadcast message, a groupcast message, and/or a unicast message. In response to receiving the request, the UEs may transmit the measurements of the first reference signal(s) and/or the measurements of the second reference signal(s) to the network unit. In some aspects, the network unit may transmit a configuration (e.g., a configured grant) to the UEs indicating the time resources and/or frequency resources the UEs may use to transmit the measurements to the network unit.

In some aspects, the network unit may receive the measurements of the first and/or second reference signal(s) from the UEs via uplink control information (UCI), a physical uplink control channel (PUCCH) communication, a physical uplink shared channel (PUSCH) communication, or other suitable communication. The network unit may transmit an indicator (e.g., a configured grant) to the UEs indicating time resources and/or frequency resources via which the UEs may transmit the measurements to the network unit.

In some aspects, the network unit may receive measurements of the first reference signal(s) and/or second reference signal(s) indicated in measurement units. For example, the measurement units may include a power level, a decibel level, a ratio, an angle (AOA), a covariance matrix, an index value, or other suitable measurement units. The network unit may receive the measurements in measurement units and compare the measurements by determining whether a difference between at least one of the measurements of the first reference signal(s) and at least one of the measurements of the second reference signal(s) satisfies a threshold.

Additionally or alternatively, the network unit may receive an indicator from the UEs indicating the comparison of the measurements of the first reference signal(s) with the measurements of the second reference signal(s). For example, the UEs may compare the measurements by determining whether a difference between at least one of the measurements of the first reference signal(s) and at least one of the measurements of the second reference signal(s) satisfies a threshold. The network unit may receive an indicator indicating whether the difference satisfies the threshold. For example, the network unit may receive a binary value of “1” indicating the difference satisfies the threshold or a binary value of “0” indicating the difference does not satisfy the threshold. Additionally or alternatively, the network unit may receive a binary value of “0” indicating the difference satisfies the threshold or a binary value of “1” indicating the difference does not satisfy the threshold.

In some aspects, the network unit may receive measurements of the first reference signal(s) indicated as an average of the measurements of the first reference signal(s). In some aspects, the network unit may receive measurements of the second reference signal(s) indicated as an average of the measurements of the second reference signal(s). In this regard, the UEs may perform measurements of the first reference signal(s) and/or second reference signal(s) over a time period. The time period may be a number of symbols, a number of slots, a number of frames, a number of subframes, a number of milliseconds or other suitable time period. The UEs may determine (e.g., compute) an average of the measurements of the first reference signal(s) and/or second reference signal(s) over the time period. The network unit may receive the average of the measurements via UCI, a PUCCH communication, a PUSCH communication, or other suitable communication. The network unit may receive the average of the measurements in measurement units and compare the average of the measurements by determining whether a difference between at least one of the average measurements of the first reference signal(s) and at least one of the average measurements of the second reference signal(s) satisfies a threshold.

In some aspects, the UEs may be geographically distributed. In this regard, the UEs may be geographically distributed across different geographic zones 450 and/or 452 (e.g., different geographic areas). The zones 450 and/or 452 may be partially overlapping or non-overlapping. The network unit may transmit a zone identifier (ID) to the UEs indicating which zone 450 and/or 452 the respective UE is in. The network unit may determine which zone 450 and/or 452 the UEs are in based on receiving GPS coordinates from the UEs, radio frequency triangulation, or other suitable positioning method. In some aspects, the network unit may update the zone IDs based on the mobility of the UEs. For example, the network unit may transmit an updated zone ID to a UE when the network unit detects that the UE moved from one zone to another zone.

In some aspects, the network unit may receive the measurements of the first reference signal(s) and/or the measurements of the second reference signal(s) from a master node UE. In some aspects, one or more zones may include one or more master node UEs. The master node UE may receive the measurements of the first reference signal(s) and/or the second reference signal(s) from the UEs within a zone that includes the master node UE and the UEs. The master node UE may collect the measurements and transmit (e.g., relay, forward) the measurements to the network unit. In some aspects, the master node UE may receive the measurements from the UEs as measurement units (e.g., power level, a decibel level, a ratio, an angle (AOA), a covariance matrix, an index value), an average of measurement units, an indicator (e.g., binary indicator) indicating the comparison of the measurements, or a combination thereof. The master node UE may transmit the measurements to the network unit as measurement units, an average of measurement units, an indicator (e.g., binary indicator) indicating the comparison of the measurements, or a combination thereof. For example, the network unit may receive an indicator from the master node UE indicating the comparison of the measurements of the first reference signal(s) with the measurements of the second reference signal(s). For example, the master node UE may compare the measurements by determining whether a difference between at least one of the measurements of the first reference signal(s) and at least one of the measurements of the second reference signal(s) satisfies a threshold. If the master node UE is out of coverage of the network unit, the master node UE may use another master node UE or a UE to relay the measurements to the network unit. For example, the master node UE may transmit the measurements via a sidelink communication to one or more master node UEs or UEs to relay the measurements to the network unit. In some aspects, the master node UE may include a programmable logic controller, a hub, a router, a smartphone, or other suitable electronic device.

At action 1230, the method 1200 includes the network unit detecting an unintended signal reflection associated with the RIS. The network unit may detect the unintended signal reflection based on a comparison of measurements associated with the one or more first reference signal(s) with measurements associated with the one or more second reference signal(s). In this regard, detecting the unintended signal reflection associated with the RIS may include detecting a hack and/or interference associated with a controller of the RIS. The RIS may include a controller (e.g., a microcontroller, a processor 1002, a processor 1102, a field programmable gate array, or other suitable controller) that controls the elements and operation of the RIS. For example, the network unit may transmit a configuration to the RIS controller to set the reflection angle of the RIS. The RIS controller may set the reflection angle based on the configuration from the network unit. In some aspects, the RIS controller may be hacked and/or otherwise interfered with (e.g., intentionally or unintentionally by a third party) such that the reflection angle of the RIS (e.g., a portion of the RIS, a subset of elements of the RIS) is changed from the network unit setting thereby causing unintended signal reflections. In some aspect, the hack and/or interference may include a malicious hack intended to cause a denial of service.

In some aspects, the network unit may detect the unintended signal reflection based on the covariance matrix:

$$Gi ΦΦ attack H - Gi Φ H$$

Where Gi represents the channel between the RIS and the UE, Φ is a square matrix of a size based on the number of RIS elements and represents the RIS configuration set by the network unit (intended reflections), H represents the channel between the network unit and the RIS, and Φattack represents the unintended signal reflections.

In response to detecting the unintended signal reflection associated with the RIS, the network unit may perform one or more remedial actions. In some aspects, the network unit may attempt to reconfigure the RIS to reflect signals in the intended direction. The network unit may retransmit the configuration setting to the RIS controller, request additional reference signal measurements from the UEs to perform additional detection methods, transmit a command to the RIS controller to turn off power to the RIS, transmit a command to the RIS controller to disable a portion (e.g., a cluster of elements) of the RIS in which the unintended signal reflection was detected, or other suitable remedial action.

In some aspects, the network unit may detect the unintended signal reflection associated with the RIS based on a probability that the RIS is reflecting signals in an unintended direction. The network unit may detect the unintended signal reflection when the probability satisfies a threshold (e.g., greater than or equal to the threshold). The probability may be determined based on the number of UEs that indicate a difference between the measurements of the first and second reference signal(s) satisfies a threshold (e.g., greater than and/or equal to the threshold). For example, when a threshold number of UEs (e.g., a raw number of UEs and/or a percentage of UEs) in a zone indicate a difference between the measurements of the first and second reference is greater than and/or equal to the threshold, the network unit may consider an unintended signal reflection as having been detected. As another example, when one or more UEs (e.g., a raw number of UEs and/or a percentage of UEs) in a zone indicate a threshold number of comparisons (e.g., a raw number of comparisons and/or a percentage of comparisons) over time indicate a difference between the measurements of the first and second reference is greater than and/or equal to the threshold, the network unit may consider an unintended signal reflection as having been detected.

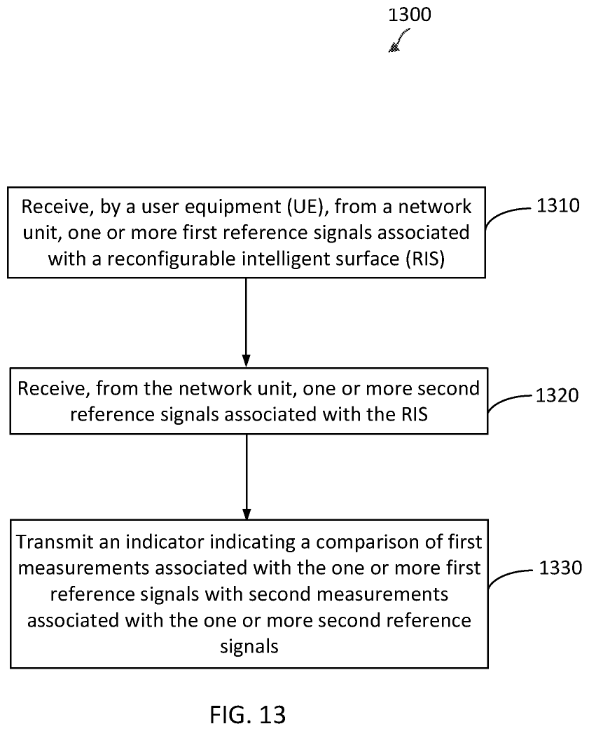

FIG. 13 is a flow diagram of a communication method 1300 according to some aspects of the present disclosure. Aspects of the method 1300 can be executed by a computing device (e.g., a processor, processing circuit, and/or other suitable component) of a wireless communication device or other suitable means for performing the actions. For example, a wireless communication device, such as the UE 115 or UE 1000, may utilize one or more components, such as the processor 1002, the memory 1004, the RIS detection module 1008, the transceiver 1010, the modem 1012, and the one or more antennas 1016, to execute aspects of method 1300. The method 1300 may employ similar mechanisms as in the networks 100 and 200 and the aspects and actions described with respect to FIGS. 3-9. As illustrated, the method 1300 includes a number of enumerated actions, but the method 1300 may include additional actions before, after, and in between the enumerated actions. In some aspects, one or more of the enumerated actions may be omitted or performed in a different order.

At action 1310, the method 1300 includes a UE (e.g., the UE 115 or UE 1000,) receiving one or more first reference signal(s) from a network unit (e.g., the network unit 1100, the BS 105, the RU 240, the DU 230, and/or the CU 210). The first reference signal(s) may include a synchronization signal block (SSB), a primary synchronization signal (PSS), a secondary synchronization signal (SSS), a cell specific reference signal (CRS), a demodulation reference signal (DMRS), a channel state information reference signal (CSI-RS), a phase tracking reference signal (PTRS), and/or other suitable reference signal. For example, when the UE operates in a new radio (NR) mode, the reference signal may include a synchronization signal block (SSB), a primary synchronization signal (PSS), and/or a secondary synchronization signal (SSS), a demodulation reference signal (DMRS), a channel state information reference signal (CSI-RS), or a phase tracking reference signal (PTRS). When the UE operates in a long term evolution (LTE) mode, the reference signal may include a cell specific reference signal (CRS).

In some aspects, the UE may directly receive the first reference signal(s) from the network unit. Additionally or alternatively, the UE may receive the first reference signal(s) from the network unit via a reconfigurable intelligent surface (RIS) (e.g., the RIS 310 of FIGS. 3-7). In some aspects, the RIS may be deployed to control one or more channels and/or signal propagation paths between the network unit and the UEs. The RIS may control the channel(s) and/or signal propagation path(s) by reflecting, forming, and/or modulating the radio signals from the network unit to the UEs and/or from the UEs to the network unit. That is, in some instances the RIS may modify an incident radio signal waveform in a controlled manner to enhance and/or improve channel diversities. Increasing channel diversities may provide robustness to channel blocking and/or fading, which may be particularly useful for mmWave communications and other communications. The transmitted (e.g., incident) first reference signal(s) may be reflected by the RIS by adjusting phase shifts that constructively interfere and/or steer the reflected reference signal(s) towards the UEs in order to effectively control multi-path effects. In some instances, the RIS may steer the reflected reference signal(s) through 3-dimensional passive beamforming, thereby improving spectrum and/or energy efficiency. The RIS may be configured to forward (e.g., reflect) a more efficient phase-shifted version of the incident reference signal(s) and/or shape channel propagation to adapt against channel variations due to unpredictable wireless environments.

In some aspects, the network unit may transmit the first reference signal(s) using a transmit beam, a transmit port, and a RIS configuration. The transmit beam may include a direction in which the first reference signal(s) are transmitted by the network unit. For example, referring to FIG. 3, the network unit may transmit the first reference signal(s) in a direction 420 towards the UE (e.g., a geographic zone 450 and/or 452 that includes the UE). Additionally or alternatively, the network unit may transmit the first reference signal(s) in a direction 422 towards the RIS. The network unit may transmit the first reference signal(s) in a direction 422 towards the RIS such that the RIS reflects the reference signal(s) in a direction 424 towards the UE (e.g., a geographic zone 450 and/or 452 that includes the UE).

The transmit beam may further include a beam width. For example, the network unit may transmit the first reference signal(s) using a wide beam width covering a wide area and/or a narrow beam width concentrating the reference signal(s) into a narrow area. The transmit port may indicate the antenna port(s) of the network unit used to transmit the first reference signal(s). The RIS configuration may include a configuration transmitted by the network unit to a control unit of the RIS (e.g., RIS controller). The RIS configuration may include the parameters to be used by the RIS when the first reference signal(s) are reflected towards the UEs. The parameters of the RIS configuration may include angle of reflection, signal amplitude changes, signal polarization changes, signal phase changes, and/or other suitable RIS parameters.

In some aspects, the UE may measure one or more parameters associated with the first reference signal(s). In this regard, the measurements of the first reference signal(s) may include at least one of a reference signal received power (RSRP) associated with the first reference signal(s), a reference signal received quality (RSRQ) associated with the first reference signal(s), a signal to interference and noise ratio (SINR) associated with the first reference signal(s), a covariance matrix associated with the first reference signal(s), an angle of arrival (AoA) associated with the first reference signal(s), and/or other suitable parameters.

In some aspects, the UE may receive the first reference signal(s) at a first periodicity (e.g., the reference measurement periodicity 810) and receive the second reference signal(s) at a second periodicity (e.g., the RIS beam measurement periodicity 820). The second periodicity may be a multiple (e.g., an integer multiple) of the first periodicity. For example, the UE may receive the first reference signal(s) every x time periods. The time period may be a number of symbols, a number of slots, a number of frames, a number of subframes, a number of milliseconds or other suitable time period. The UE may receive the second reference signal(s) every xy time periods, where y is an integer. In some aspects, the measurements associated with the first reference signal(s) may represent a baseline set of measurements. The UE may perform the measurements periodically. For example, the UE may perform the measurements at the reference measurement periodicity 810 as shown in FIG. 8. When the UE performs reference signal measurements to gain a baseline measurement, the new baseline measurements replace the previous baseline measurements. When the first reference signal(s) are received by the UE from the network unit via the RIS, the RIS may be in an operating condition in which the RIS reflects the reference signal(s) according to a configuration set by the network unit. The RIS may reflect the reference signal(s) in an intended direction according to the configuration set by the network unit. Aspects of the present disclosure may determine when the reference signal(s) are reflected in an unintended direction based on a comparison of the measurements of the first reference signal(s) with measurements of one or more second reference signal(s) as described in detail below.

At action 1320, the method 1300 includes the UE receiving one or more second reference signal(s) from the network unit. The second reference signal(s) may include a SSB, a PSS, a SSS, a CRS, a DMRS, a CSI-RS, a PTRS, and/or other suitable reference signal(s). In some aspects, the second reference signal(s) may be the same or different type of reference signal(s) as the first reference signal(s).

In some aspects, the UE may receive the second reference signal(s) from the network unit via the RIS. In some aspects, the network unit may transmit the second reference signal(s) using the same transmit beam, same transmit port, and same RIS configuration as the first reference signal(s) transmitted by the network unit at action 1310. In some instances, the network unit may transmit the second reference signal(s) using the same transmit beam, same transmit port, and same RIS configuration as the first reference signal(s) in order to facilitate a comparison of measurements between the first and second reference signal(s) based on the same reference signal configuration.

In some aspects, the UE may measure one or more parameter(s) associated with the second reference signal(s). The UE may perform the same measurements as those performed on the first reference signal measurements. In this regard, the measurements of the second reference signal(s) may include at least one of a RSRP associated with the second reference signal(s), a RSRQ associated with the second reference signal(s), a SINR associated with the second reference signal(s), a covariance matrix associated with the second reference signal(s), an AoA associated with the second reference signal(s), and/or other suitable parameter(s).

A comparison of the measurements of the first reference signal(s) with the measurements of the second reference signal(s) may be used to determine if the RIS is operating according to a configuration set by the network unit. When the first reference signal(s) are received by the UE via the RIS, the RIS may be in an operating condition in which the RIS reflects the reference signal(s) according to the configuration set by the network unit. The RIS may reflect the reference signal(s) in an intended direction according to the configuration set by the network unit. The measurements of the second reference signal(s) may occur after the first reference signal measurements (e.g., the baseline measurements) and over one or more times (e.g., periodically). The measurements of the second reference signal(s) may be compared to the first reference signal measurements as a check to determine if the RIS is still operating according to the configuration. The check to determine if the RIS is still operating according to the configuration may be done on a periodic basis. For example, the RIS operational check may be performed at the reference measurement periodicity 810, the RIS beam measurement periodicity 820, or other suitable periodicity. In some aspects, the RIS operational check may be triggered by an event. For example, the event may include the network unit receiving a message requesting to perform the RIS operational check, the network unit may detect one or more radio link failures, or other suitable event. If the comparison of the first reference signal measurements with the second reference signal measurements indicates a difference over a threshold, the RIS (e.g., a portion of the RIS) may not be operating according to the configuration (e.g., the reference signal(s) are reflected in an unintended direction). In some aspect, the RIS may not be operating according to the set configuration based on the RIS controller being hacked.

Additionally or alternatively, the UE may receive a request from the network unit for the measurements of the first reference signal(s) and/or the measurements of the second reference signal(s). In this regard, the UE may periodically and/or aperiodically receive the request from the network unit via a radio resource control (RRC) communication, downlink control information (DCI), a medium access control control element (MAC-CE), a physical downlink control channel (PDCCH) communication, a physical downlink shared channel (PDSCH) communication, or other suitable communication. In some aspects, the UE may aperiodically receive the request from the network unit via a broadcast message, a groupcast message, and/or a unicast message. In response to receiving the request, the UE may transmit the measurements of the first reference signal(s) and/or the measurements of the second reference signal(s) to the network unit. In some aspects, the network unit may transmit a configuration (e.g., a configured grant) to the UE indicating the time resources and/or frequency resources the UE may use to transmit the measurements to the network unit.

In some aspects, the UE may transmit the measurements of the first and/or second reference signal(s) to the network unit via uplink control information (UCI), a physical uplink control channel (PUCCH) communication, a physical uplink shared channel (PUSCH) communication, or other suitable communication. The UE may receive an indicator (e.g., a configured grant) from the network unit indicating time resources and/or frequency resources via which the UEs may transmit the measurements to the network unit.

In some aspects, the UE may transmit measurements of the first reference signal(s) and/or second reference signal(s) indicated in measurement units. For example, the measurement units may include a power level, a decibel level, a ratio, an angle (AOA), a covariance matrix, an index value, or other suitable measurement units. The network unit may receive the measurements in measurement units and compare the measurements by determining whether a difference between at least one of the measurements of the first reference signal(s) and at least one of the measurements of the second reference signal(s) satisfies a threshold.

At action 1330, the method 1300 includes the UE transmitting an indicator to the network unit indicating the comparison of the measurements of the first reference signal(s) with the measurements of the second reference signal(s). For example, the UE may compare the measurements by determining whether a difference between at least one of the measurements of the first reference signal(s) and at least one of the measurements of the second reference signal(s) satisfies a threshold. The UE may transmit an indicator indicating whether the difference satisfies the threshold. For example, the UE may transmit a binary value of “1” indicating the difference satisfies the threshold or a binary value of “0” indicating the difference does not satisfy the threshold. Additionally or alternatively, the UE may transmit a binary value of “0” indicating the difference satisfies the threshold or a binary value of “1” indicating the difference does not satisfy the threshold.

In some aspects, the UE may transmit measurements of the first reference signal(s) indicated as an average of the measurements of the first reference signal(s). In some aspects, the UE may transmit measurements of the second reference signal(s) indicated as an average of the measurements of the second reference signal(s). In this regard, the UE may perform measurements of the first reference signal(s) and/or second reference signal(s) over a time period. The time period may be a number of symbols, a number of slots, a number of frames, a number of subframes, a number of milliseconds or other suitable time period. The UE may determine (e.g., compute) an average of the measurements of the first reference signal(s) and/or second reference signal(s) over the time period. The UE may transmit the average of the measurements via UCI, a PUCCH communication, a PUSCH communication, or other suitable communication. The network unit may receive the average of the measurements in measurement units and compare the average of the measurements by determining whether a difference between at least one of the average measurements of the first reference signal(s) and at least one of the average measurements of the second reference signal(s) satisfies a threshold.

In some aspects, UEs may be geographically distributed. In this regard, the UEs may be geographically distributed across different geographic zones 450 and/or 452 (e.g., different geographic areas). The zones 450 and/or 452 may be partially overlapping or non-overlapping. The UE may receive a zone identifier (ID) from the network unit indicating which zone 450 and/or 452 the UE is in. The network unit may determine which zone 450 and/or 452 the UE is in based on receiving GPS coordinates from the UE, radio frequency triangulation, or other suitable positioning method. In some aspects, the network unit may update the zone IDs based on the mobility of the UE. For example, the network unit may transmit an updated zone ID to the UE when the network unit detects that the UE moved from one zone to another zone.

In some aspects, the network unit may receive the measurements of the first reference signal(s) and/or the measurements of the second reference signal(s) from a master node UE. In some aspects, one or more zones may include one or more master node UEs. The master node UE may receive the measurements of the first reference signal(s) and/or the second reference signal(s) from the UE within a zone that includes the master node UE and the UE. The master node UE may collect the measurements and transmit (e.g., relay, forward) the measurements to the network unit. In some aspects, the master node UE may receive the measurements from the UE as measurement units (e.g., power level, a decibel level, a ratio, an angle (AOA), a covariance matrix, an index value), an average of measurement units, an indicator (e.g., binary indicator) indicating the comparison of the measurements, or a combination thereof. The master node UE may transmit the measurements to the network unit as measurement units, an average of measurement units, an indicator (e.g., binary indicator) indicating the comparison of the measurements, or a combination thereof. For example, the network unit may receive an indicator from the master node UE indicating the comparison of the measurements of the first reference signal(s) with the measurements of the second reference signal(s). For example, the master node UE may compare the measurements by determining whether a difference between at least one of the measurements of the first reference signal(s) and at least one of the measurements of the second reference signal(s) satisfies a threshold. If the master node UE is out of coverage of the network unit, the master node UE may use another master node UE or a UE to relay the measurements to the network unit. For example, the master node UE may transmit the measurements via a sidelink communication to one or more master node UEs or UEs to relay the measurements to the network unit. In some aspects, the master node UE may include a programmable logic controller, a hub, a router, a smartphone, or other suitable electronic device.

In some aspects, the network unit may detect an unintended signal reflection associated with the RIS. The network unit may detect the unintended signal reflection based on a comparison of measurements associated with the one or more first reference signal(s) with measurements associated with the one or more second reference signal(s).

In some aspects, the network unit may detect the unintended signal reflection based on the covariance matrix:

$$Gi ΦΦ attack H - Gi Φ H$$

Where Gi represents the channel between the RIS and the UE, Φ is a square matrix of a size based on the number of RIS elements and represents the RIS configuration set by the network unit (intended reflections), H represents the channel between the network unit and the RIS, and Φattack represents the unintended signal reflections.

In some aspects, detecting the unintended signal reflection associated with the RIS may include detecting a hack and/or interference associated with a controller of the RIS. The RIS may include a controller (e.g., a microcontroller, a processor 1002, a processor 1102, a field programmable gate array, or other suitable controller) that controls the elements and operation of the RIS. For example, the network unit may transmit a configuration to the RIS controller to set the reflection angle of the RIS. The RIS controller may set the reflection angle based on the configuration from the network unit. In some aspects, the RIS controller may be hacked and/or otherwise interfered with (e.g., intentionally or unintentionally by a third party) such that the reflection angle of the RIS (e.g., a portion of the RIS, a subset of elements of the RIS) is changed from the network unit setting thereby causing unintended signal reflections. In some aspect, the hack and/or interference may include a malicious hack intended to cause a denial of service.

In response to detecting the unintended signal reflection associated with the RIS, the network unit may perform one or more remedial actions. In some aspects, the network unit may attempt to reconfigure the RIS to reflect signals in the intended direction. The network unit may retransmit the configuration setting to the RIS controller, request additional reference signal measurements from the UEs to perform additional detection methods, transmit a command to the RIS controller to turn off power to the RIS, transmit a command to the RIS controller to disable a portion (e.g., a cluster of elements) of the RIS in which the unintended signal reflection was detected, or other suitable remedial action.

In some aspects, the network unit may detect the unintended signal reflection associated with the RIS based on a probability that the RIS is reflecting signals in an unintended direction. The network unit may detect the unintended signal reflection when the probability satisfies a threshold (e.g., greater than or equal to the threshold). The probability may be determined based on the number of UEs that indicate a difference between the measurements of the first and second reference signal(s) satisfies a threshold (e.g., greater than and/or equal to the threshold). For example, when a threshold number of UEs (e.g., a raw number of UEs and/or a percentage of UEs) in a zone indicate a difference between the measurements of the first and second reference is greater than and/or equal to the threshold, the network unit may consider an unintended signal reflection as having been detected. As another example, when one or more UEs (e.g., a raw number of UEs and/or a percentage of UEs) in a zone indicate a threshold number of comparisons (e.g., a raw number of comparisons and/or a percentage of comparisons) over time indicate a difference between the measurements of the first and second reference is greater than and/or equal to the threshold, the network unit may consider an unintended signal reflection as having been detected.

Further aspects of the present disclosure include the following:
Aspect 1 includes a method of wireless communication performed by a network unit, the method comprising transmitting, to one or more user equipment (UEs), one or more first reference signals; transmitting, to the one or more user equipment (UEs), one or more second reference signals; and detecting an unintended signal reflection associated with a reconfigurable intelligent surface (RIS) based on a comparison of first measurements associated with the one or more first reference signals with second measurements associated with the one or more second reference signals.
Aspect 2 includes the method of aspect 1, wherein the detecting the unintended signal reflection associated with the RIS comprises detecting a hack associated with a controller of the RIS.
Aspect 3 includes the method of any of aspects 1-2, wherein the transmitting the one or more first reference signals comprises transmitting the one or more first reference signals via the RIS.
Aspect 4 includes the method of any of aspects 1-3, wherein the transmitting the one or more second reference signals comprises transmitting the one or more second reference signals via the RIS.
Aspect 5 includes the method of any of aspects 1-4, wherein the comparison of the first measurements with the second measurements comprises determining whether a difference between at least one of the first measurements and at least one of the second measurements satisfies a threshold.
Aspect 6 includes the method of any of aspects 1-5, further comprising, receiving from the one or more UEs, an indicator indicating the comparison of the first measurements with the second measurements.
Aspect 7 includes the method of any of aspects 1-6, wherein the configuration comprises the RAT indicator, wherein the RAT indicator indicates a long term evolution (LTE) RAT; and the reference signal comprises at least one of a secondary synchronization signal (SSS); or a cell specific reference signal (CRS).
Aspect 8 includes the method of any of aspects 1-7, further comprising determining a probability associated with the unintended signal reflection, wherein the probability is based on at least one of a number of the one or more UEs or a number of comparisons of the first measurements with the second measurements performed over time.
Aspect 9 includes the method of any of aspects 1-8, wherein the transmitting the first reference signals comprises transmitting the first reference signals at a first time period; and transmitting the second references signals comprises transmitting the second reference signals at a second time period, wherein the second time period occurs after the first time period.
Aspect 10 includes the method of any of aspects 1-9, wherein the transmitting the one or more first reference signals comprises transmitting the one or more first reference signals using a transmit beam, a transmit port, and a RIS configuration; and the transmitting the one or more second reference signals comprises transmitting the one or more second reference signals using the transmit beam, the transmit port, and the RIS configuration.
Aspect 11 includes the method of any of aspects 1-10, wherein the transmitting the one or more first reference signals comprises transmitting the one or more first reference signals at a first periodicity; the transmitting the one or more second reference signals comprises transmitting the one or more second reference signals at a second periodicity; and the first periodicity is longer than the second periodicity.
Aspect 12 includes the method of any of aspects 1-11, further comprising receiving, from the one or more UEs, the first measurements associated with the one or more first reference signals; and receiving, from the one or more UEs, the second measurements associated with the one or more second reference signals.
Aspect 13 includes the method of any of aspects 1-12, further comprising transmitting, to the one or more UEs, an indicator indicating time and frequency resources, wherein at least one of the receiving the first measurements comprises receiving the first measurements in the time and frequency resources; or the receiving the second measurements comprises receiving the second measurements in the time and frequency resources.
Aspect 14 includes the method of any of aspects 1-13, further comprising receiving, from the one or more UEs, an average of the first measurements associated with the one or more first reference signals; and receiving, from the one or more UEs, an average of the second measurements associated with the one or more second reference signals.
Aspect 15 includes the method of any of aspects 1-14, wherein the one or more UEs comprises a plurality of UEs located in a plurality of zones.
Aspect 16 includes the method of any of aspects 1-15, further comprising transmitting, to each of the plurality of UEs, a zone identifier indicating a respective zone of the plurality of zones associated with the UE.
Aspect 17 includes the method of any of aspects 1-16, further comprising receiving, from a master node UE, an average of the first measurements in a first zone of the plurality of zones; and receiving, from the master node UE, an average of the second measurements in a second zone of the plurality of zones.
Aspect 18 includes the method of any of aspects 1-17, wherein the comparison of the first measurements with the second measurements is based on an uncertainty level associated with at least one of the first zone or the second zone.
Aspect 19 includes the method of any of aspects 1-18, further comprising transmitting, to a plurality of UEs in a first zone of the plurality of zones, a request for at least one of the first measurements or the second measurements.
Aspect 20 includes the method of any of aspects 1-19, wherein the transmitting the request comprises transmitting the request via at least one of a broadcast communication, a groupcast communication, or a unicast communication.
Aspect 21 includes the method of any of aspects 1-20, wherein the one or more first reference signals comprise at least one of synchronization signal blocks (SSBs), demodulation reference signals (DMRSs), channel state information reference signals (CSI-RSs), phase tracking reference signals (PTRS), or cell specific reference signals (CRSs); and he one or more second reference signals comprise at least one of SSBs, DMRSs, CSI-RSs, PTRS, or CRSs.
Aspect 22 includes the method of any of aspects 1-21, wherein the first measurements comprise at least one of a reference signal received power (RSRP) associated with the one or more first reference signals, a reference signal received quality (RSRQ) associated with the one or more first reference signals, a signal to interference and noise ratio (SINR) associated with the one or more first reference signals, a covariance matrix associated with the one or more first reference signals, or an angle of arrival (AoA) associated with the one or more first reference signals.
Aspect 23 includes the method of any of aspects 1-22, wherein the second measurements comprise at least one of a reference signal received power (RSRP) associated with the one or more second reference signals, a reference signal received quality (RSRQ) associated with the one or more second reference signals, a signal to interference and noise ratio (SINR) associated with the one or more second reference signals, a covariance matrix associated with the one or more second reference signals, or an angle of arrival (AoA) associated with the one or more second reference signals.
Aspect 24 includes the method of any of aspects 1-23, wherein the detecting the unintended signal reflection associated with the RIS comprises detecting the unintended signal reflection associated with a portion of the RIS.
Aspect 25 includes the method of any of aspects 1-24, further comprising transmitting, to a controller of the RIS, a command to disable at least a portion of the RIS based on the detecting the unintended signal reflection associated with the RIS.
Aspect 26 includes a method of wireless communication performed by a user equipment (UE), the method comprising receiving, from a network unit, one or more first reference signals associated with a reconfigurable intelligent surface (RIS); receiving, from the network unit, one or more second reference signals associated with the RIS; and transmitting an indicator indicating a comparison of first measurements associated with the one or more first reference signals with second measurements associated with the one or more second reference signals.
Aspect 27 includes the method of aspect 26, wherein the receiving the one or more first reference signals comprises receiving the one or more first reference signals via the RIS.
Aspect 28 includes the method of any of aspects 26-27, wherein the receiving the one or more second reference signals comprises receiving the one or more second reference signals via the RIS.
Aspect 29 includes the method of any of aspects 26-28, wherein the comparison of the first measurements with the second measurements comprises determining whether a difference between at least one of the first measurements and at least one of the second measurements satisfies a threshold.
Aspect 30 includes the method of any of aspects 26-29, further comprising, transmitting, to the network unit, an indicator indicating the comparison of the first measurements with the second measurements.
Aspect 31 includes the method of any of aspects 26-30, wherein the indicator comprises a binary value indicating whether a difference between the first measurements and the second measurements satisfies a threshold.
Aspect 32 includes the method of any of aspects 26-31, wherein the receiving the first reference signals comprises receiving the first reference signals at a first time period; and receiving the second references signals comprises receiving the second reference signals at a second time period, wherein the second time period occurs after the first time period.
Aspect 33 includes the method of any of aspects 26-32, wherein the receiving the one or more first reference signals comprises receiving the one or more first reference signals using a transmit beam, a transmit port, and a RIS configuration; and the receiving the one or more second reference signals comprises receiving the one or more second reference signals using the transmit beam, the transmit port, and the RIS configuration.
Aspect 34 includes the method of any of aspects 26-33, wherein the receiving the one or more first reference signals comprises receiving the one or more first reference signals at a first periodicity; the receiving the one or more second reference signals comprises receiving the one or more second reference signals at a second periodicity; and the first periodicity is longer than the second periodicity.
Aspect 35 includes the method of any of aspects 26-34, further comprising transmitting, to the network unit, the first measurements associated with the one or more first reference signals; and transmitting, to the network unit, the second measurements associated with the one or more second reference signals.
Aspect 36 includes the method of any of aspects 26-35, further comprising receiving, from the network unit, an indicator indicating time and frequency resources, wherein at least one of the transmitting the first measurements comprises transmitting the first measurements in the time and frequency resources; or the transmitting the second measurements comprises transmitting the second measurements in the time and frequency resources.
Aspect 37 includes the method of any of aspects 26-36, wherein the UE comprises a master node UE, the method further comprising transmitting, to the network unit, an average of the first measurements associated with the one or more first reference signals; and transmitting, to the network unit, an average of the second measurements associated with the one or more second reference signals.
Aspect 38 includes the method of any of aspects 26-37, further comprising receiving, from the network unit, a zone identifier indicating a zone associated with the UE.
Aspect 39 includes the method of any of aspects 26-38, further comprising transmitting, to a master node UE, an average of the first measurements in the zone; and transmitting, to the master node UE, an average of the second measurements in the zone.
Aspect 40 includes the method of any of aspects 26-39, further comprising receiving, from the network unit, a request for at least one of the first measurements or the second measurements.
Aspect 41 includes the method of any of aspects 26-40, wherein the receiving the request comprises receiving the request via at least one of a broadcast communication, a groupcast communication, or a unicast communication.
Aspect 42 includes the method of any of aspects 26-41, wherein the one or more first reference signals comprise at least one of synchronization signal blocks (SSBs), demodulation reference signals (DMRSs), channel state information reference signals (CSI-RSs), phase tracking reference signals (PTRS), or cell specific reference signals (CRSs); and the one or more second reference signals comprise at least one of SSBs, DMRSs, CSI-RSs, PTRS, or CRSs.
Aspect 43 includes the method of any of aspects 26-42, wherein the first measurements comprise at least one of a reference signal received power (RSRP) associated with the one or more first reference signals, a reference signal received quality (RSRQ) associated with the one or more first reference signals, a signal to interference and noise ratio (SINR) associated with the one or more first reference signals, a covariance matrix associated with the one or more first reference signals, or an angle of arrival (AoA) associated with the one or more first reference signals.
Aspect 44 includes the method of any of aspects 26-43, wherein the second measurements comprise at least one of a reference signal received power (RSRP) associated with the one or more second reference signals, a reference signal received quality (RSRQ) associated with the one or more second reference signals, a signal to interference and noise ratio (SINR) associated with the one or more second reference signals, a covariance matrix associated with the one or more second reference signals, or an angle of arrival (AoA) associated with the one or more second reference signals.
Aspect 45 includes a non-transitory computer-readable medium storing one or more instructions for wireless communication, the one or more instructions comprising one or more instructions that, when executed by one or more processors of a network unit cause the network unit to perform any one of aspects 1-25.
Aspect 46 includes a non-transitory computer-readable medium storing one or more instructions for wireless communication, the one or more instructions comprising one or more instructions that, when executed by one or more processors of a user equipment (UE), cause the UE to perform any one of aspects 26-44.
Aspect 47 includes a network unit comprising one or more means to perform any one or more of aspects 1-25.
Aspect 48 includes a user equipment (UE) comprising one or more means to perform any one or more of aspects 26-44.
Aspect 49 includes a network unit comprising a memory; a transceiver; and at least one processor coupled to the memory and the transceiver, wherein the network unit is configured to perform any one or more of aspects 1-25.
Aspect 50 includes a user equipment (UE) comprising a memory; a transceiver; and at least one processor coupled to the memory and the transceiver, wherein the UE is configured to perform any one or more of aspects 26-44.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1-7. (canceled)

8. A method of wireless communication performed by a user equipment (UE), the method comprising:
receiving, from a network unit, one or more first reference signals associated with a reconfigurable intelligent surface (RIS);
receiving, from the network unit, one or more second reference signals associated with the RIS; and
transmitting an indicator indicating a comparison of first measurements associated with the one or more first reference signals with second measurements associated with the one or more second reference signals.

9. The method of claim 8, wherein the receiving the one or more first reference signals comprises receiving the one or more first reference signals via the RIS.

10. The method of claim 8, wherein the receiving the one or more second reference signals comprises receiving the one or more second reference signals via the RIS.

11. The method of claim 8, wherein the comparison of the first measurements with the second measurements comprises determining whether a difference between at least one of the first measurements and at least one of the second measurements satisfies a threshold.

12. The method of claim 8, further comprising, transmitting, to the network unit, an indicator indicating the comparison of the first measurements with the second measurements.

13. The method of claim 12, wherein the indicator comprises a binary value indicating whether a difference between the first measurements and the second measurements satisfies a threshold.

14. The method of claim 8, wherein:
the receiving the first reference signals comprises receiving the first reference signals at a first time period; and
receiving the second references signals comprises receiving the second reference signals at a second time period, wherein the second time period occurs after the first time period.

15. The method of claim 8, wherein:
the receiving the one or more first reference signals comprises receiving the one or more first reference signals using a transmit beam, a transmit port, and a RIS configuration; and
the receiving the one or more second reference signals comprises receiving the one or more second reference signals using the transmit beam, the transmit port, and the RIS configuration.

16-22. (canceled)

23. A user equipment (UE) comprising:
a memory;
a transceiver; and
at least one processor coupled to the memory and the transceiver, wherein the UE is configured to:
receive, from a network unit, one or more first reference signals associated with a reconfigurable intelligent surface (RIS);
receive, from the network unit, one or more second reference signals associated with the RIS; and
transmit an indicator indicating a comparison of first measurements associated with the one or more first reference signals with second measurements associated with the one or more second reference signals.

24. The UE of claim 23, wherein the UE is further configured to receive the one or more first reference signals via the RIS.

25. The UE of claim 23, wherein the UE is further configured to receive the one or more second reference signals via the RIS.

26. The UE of claim 23, wherein the comparison of the first measurements with the second measurements comprises determining whether a difference between at least one of the first measurements and at least one of the second measurements satisfies a threshold.

27. The UE of claim 23, wherein the UE is further configured to transmit, to the network unit, an indicator indicating the comparison of the first measurements with the second measurements.

28. The UE of claim 27, wherein the indicator comprises a binary value indicating whether a difference between the first measurements and the second measurements satisfies a threshold.

29. The UE of claim 23, wherein the UE is further configured to:
receive the first reference signals at a first time period; and
receive the second reference signals at a second time period, wherein the second time period occurs after the first time period.

30. The UE of claim 23, wherein the UE is further configured to:
receive the one or more first reference signals using a transmit beam, a transmit port, and a RIS configuration; and
receive the one or more second reference signals using the transmit beam, the transmit port, and the RIS configuration.
